(19) United States
(12) Patent Application Publication
(10) Pub. No.: US 2006/0200336 A1
(43) Pub. Date: Sep. 7, 2006

(54) Creating a lexicon using automatic template matching

(75) Inventors: Domenic J. Cipollone, Redmond, WA (US); Ian G. Johnson, Sammamish, WA (US); Bradley A. Music, Bellevue, WA (US); Mari J. Broman Olsen, Bellevue, WA (US); Rene J. Valdes, Kirkland, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/072,577

(22) Filed: Mar. 4, 2005

(51) Int. Cl. G06F 17/28

(52) U.S. Cl. 704/4

(57) ABSTRACT

The present invention provides a lexicon development tool which allows an author to first define templates which define morphological properties of a class of words and then assign words in an input word list to correct templates. The present invention can be used to automatically match a template to an input word or the words can be matched to templates manually. In addition, the present invention can provide a wide variety of different processing components to sort or otherwise process an input word list and to test and export a lexicon, once it has been authored. The tool can provide an authoring environment to describe the lexical data of a wide variety of languages.

### BACKGROUND OF THE INVENTION

The present invention deals with lexical data. More specifically, the present invention provides a system for developing lexical data for use in a wide variety of applications, such as natural language processing applications.

Lexical data forms a core part of most natural language processing systems. Lexical data typically includes a list of word forms with links to knowledge about the linguistic properties of those word forms. Such properties may include, for example, part-of-speech, morphology, pronunciation, stress, syllable boundaries, frequency, grammar, usage or any of a wide variety of other features that comprise knowledge about the word and how it behaves in different contexts. Such properties are often essential to the linguistic coverage and accuracy of a natural language processing application. The list of word forms, with optional links to knowledge about the linguistic property of the word forms, is referred to as a lexicon.

The acquisition and coding of lexical data is often a major part of the development of a natural language processing software application. This is because development of such lexical data (or lexicons) has typically required a linguist, or other person with a combination of linguistic and computational skills to generate and compile such data. Therefore, natural language software application development companies often outsource dictionary (or lexicon) development to companies that employ linguists or other highly skilled people. Such people typically manually enter words into the lexicon, from a corpus of text, in an ad hoc way. They are provided with no structure within which to enter the words, and the result is that the entries are often inconsistent and incomplete from one person to the next. They are inconsistent because the manual dictionary builders do not enter every form of every word (such as every form of every verb, noun, etc.). They are incomplete because the manual entering personnel fail to define all rules to completely define the morphology of the words.

Another problem associated with conventional lexicon builders is that different languages have different complexity in morphological rules. Depending on the language, affixes can reside at the beginning, middle, or at the end of words, or at the beginning and end of words, or multiple suffixes can be added to a single stem. This results in even higher development costs, and the employment of even more skilled personnel, such as linguists who are professionally trained in multiple languages and who have computational skills necessary to create the electronic lexicon.

In the past, these problems have required the lexicons (or lexical data) for many useful applications (such as spell checkers and word breakers) to be licensed at extremely high, long term, license rates.

### SUMMARY OF THE INVENTION

The present invention provides a lexicon development tool which allows an author to first define templates and then assign words in an input word list to correct templates. The present invention can be used to automatically match a template to an input word or the words can be matched to templates manually. In addition, the present invention can provide a wide variety of different processing components to sort or otherwise process an input word list and to test and export a lexicon, once it has been authored.

### BRIEF DESCRIPTION OF THE DRAWINGS

FIG. 1 is one embodiment of an environment in which the present invention can be implemented.

FIG. 2 is a block diagram of one lexicon creation system in accordance with one embodiment of the present invention.

FIG. 3 is a more detailed block diagram of a lexicon generator in accordance with one embodiment of the present invention.

FIG. 4 is a flow diagram of the overall operation of the system shown in FIG. 2.

FIGS. 4A-4C illustrate three exemplary template classes.

FIG. 4D is a hierarchical tree showing a relationship between a template class, templates and assigned words.

FIGS. 4E-4G show templates more concretely.

FIG. 5 is a flow diagram illustrating how template classes and templates are authored in accordance with one embodiment of the present invention.

FIGS. 6A-6N are screenshots illustrating how templates are authored in accordance with one embodiment of the present invention.

FIG. 7 is a flow diagram illustrating one way in which lexical entries are made once the template classes and templates are defined, in accordance with one embodiment of the present invention.

FIGS. 8A-8E are screenshots illustrating how lexical entries are made in accordance with the flow diagram of FIG. 7.

FIG. 9 is a more detailed block diagram of the automatic template matching component shown in FIG. 3.

FIG. 10 is a flow diagram illustrating how lexical entries are made using automatic template matching, in accordance with one embodiment of the present invention.

FIGS. 11A-11E are screenshots illustrating the lexical entries using automatic template matching in accordance with the flow diagram shown in FIG. 10.

FIGS. 12A and 12B illustrate word list manipulation.

FIGS. 13A and 13B illustrate dependency of hierarchically arranged slots.

FIGS. 14A-21 further illustrate hierarchically arranged slots.

### DETAILED DESCRIPTION OF ILLUSTRATIVE EMBODIMENTS

The present invention deals with development of lexical data. The present description proceeds with respect to examples in the English language. However, the invention is not so limited. In various embodiments, the present invention may support all inflectional and agglutinative languages as well as Semitic languages. However, before describing the present invention in greater detail, one environment in which the present invention can be used will be described.

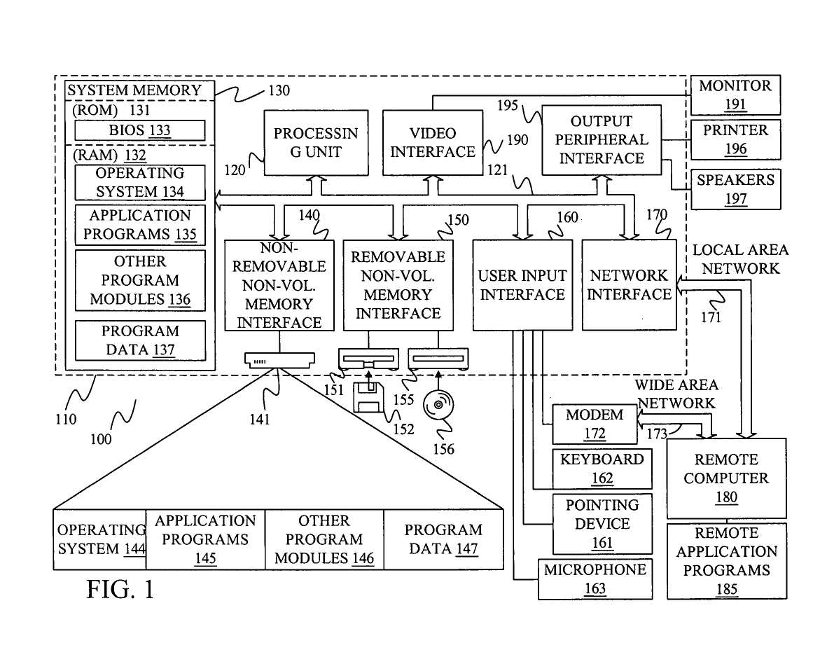

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

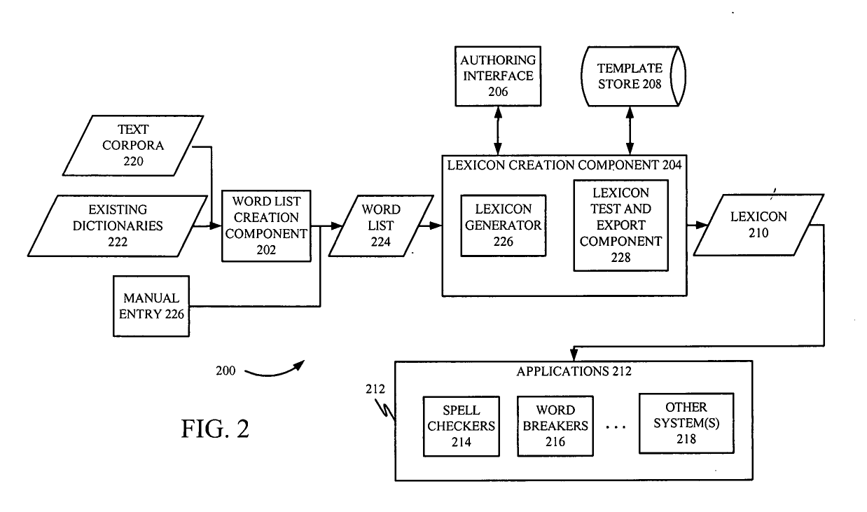

FIG. 2 is a block diagram of one illustrative embodiment of a lexical information development system 200. System 200 includes a word list creation component 202, a lexicon creation component 204 which is accessed by an author through an authoring interface component 206. Component 204 is also shown coupled to template store 208 and provides a lexicon 210, at its output, to one of a variety of applications 212. Applications 212 can include any application that requires access to a lexicon, and some examples include a spell checker 214, word breaker 216, or other system 218 (such as hyphenator, grammar checker, thesaurus, or a speech recognition or speech synthesis system).

The operation of system 200 is described in greater detail below. Briefly, however, word list creation component 202 receives a source of words from one of a variety of different sources, such as text corpora 220 or existing dictionaries 222. Word list creation component 202 then extracts a word list 224 from those sources. Alternatively, of course, word list 224 can be manually entered through a manual entry component 226. In addition, word list creation component can include more complex lexical data import utilities and word list manipulation utilities. It may also be linked to an external corpus by a key word in context (KWIC) viewing component. However, the present discussion simply proceeds with respect to component 202 creating a word list.

In any case, word list 224 is provided to lexicon creation component 204. The author has illustratively already created template classes and templates (described in greater detail below). Lexicon creation component 204 illustratively includes lexicon generator component 226 and lexicon test and export component 228. Therefore, lexicon generator 226 receives word list 224 and matches the words in the word list to templates in template store 208 to create the lexicon. As will be described in greater detail below, this can be done by manually selecting a template and entering the words, or by using automatic template matching. Either way, assigning a word to a template generates a lexical entry in the lexicon. Once the lexicon generator 226 has generated the lexicon, test and export component 228 tests the lexicon and configures it for export in one of a wide variety of desired formats. The lexicon 210 is then output in the desired format to applications 212.

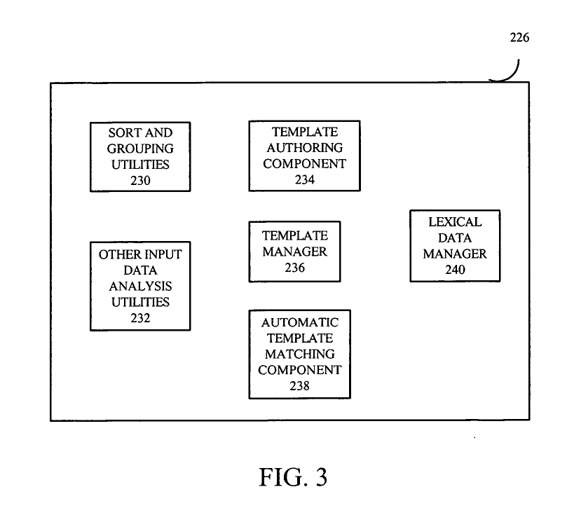

FIG. 3 is a more detailed block diagram of lexicon generator 226. FIG. 3 shows that lexicon generator 226 illustratively includes sort and grouping utilities 230, other input data analysis utilities 232, template authoring component 234, template manager 236, automatic template matching component 238 and lexical data manager 240. The description of each of these components is described in greater detail below. The description begins with template authoring component 234.

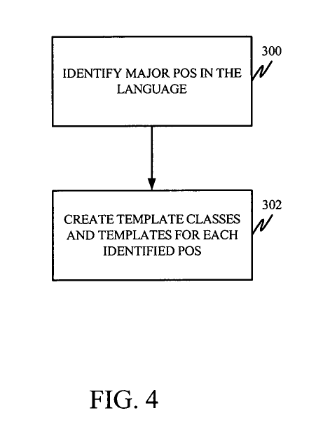

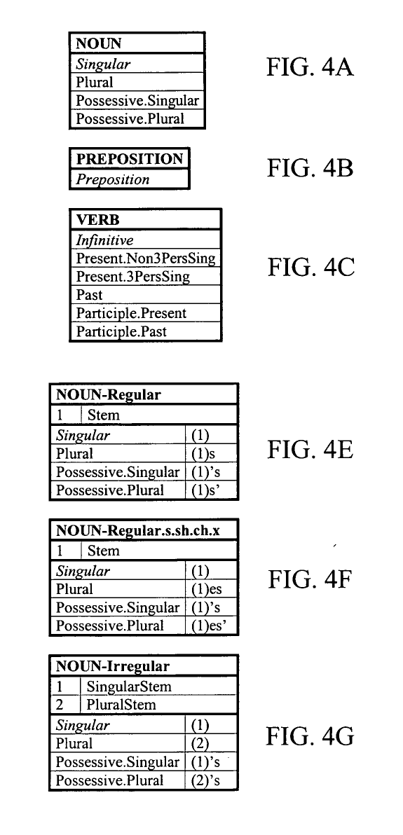

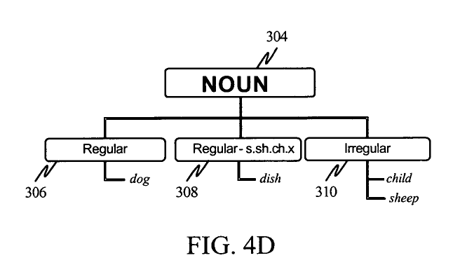

Template authoring component 234 allows an author, through authoring interface 206, to create template classes and corresponding templates. FIG. 4 is a flow diagram illustrating this process. The first step in creating template classes and templates is to identify the major parts-of-speech in the language for which the template classes and templates are being created. This is indicated by block 300 in FIG. 4. The parts-of-speech are word categories defined by two major functions which include grammatical function (how the words behave in sentences, where they can appear in relation to other kinds of words, etc.) and inflectional characteristics (i.e., the range of word forms a basic member of the word category can take without changing the part-of-speech). Typical parts-of-speech include noun, verb, adverb, adjective, pronoun, preposition, conjunction, etc. In one illustrative embodiment, template authoring component 234 stores a predefined set of parts-of-speech which can simply be selected, if they are applicable, by the author.

Therefore, by way of example, the noun part-of-speech in English is the category that contains words that can appear (among other places) as subjects and objects of verbs and prepositions (these are the grammatical functions of nouns), and that has singular, plural, and possessive forms (these are the inflectional characteristics of nouns). At this point, it is not important that different forms of nouns can be related in different ways for different words in English. All that needs to be determined is that each noun has four inflected forms, which are referred to as Singular, Plural, Possessive.Singular and Possessive.Plural. To put it another way the standard template class for nouns in English will have four slots which are used to store the four inflected words of each noun. Note that the forms that fill each of the slots need not be different, the same form can fill more than one slot.

In some languages, there are one or more irregular words that, while they intuitively belong to a particular part-of-speech, they should be treated as a separate part-of-speech for the purposes of creating templates because they contain a different set of inflectional forms. In English, for example, the verb “be” fits into this category because, although it is clearly a verb, unlike any other verb in the English language, it has multiple past tense forms (“was” for singular subjects and “were” for plural subjects). This type of verb would therefore be assigned to a special part-of-speech, such as “verb_be”.

Once the major parts-of-speech are defined, the template classes and templates are created by the author, through authoring interface 206, for each of the identified major parts-of-speech. This is indicated by block 302 in FIG. 4. A template class is a part-of-speech name (such as noun, verb, etc.) paired with a collection of generated form names corresponding to the inflectional forms associated with that part-of-speech. One of the generated forms in each template class is designated as the dictionary form and is understood as the “base” form which may typically be the form of the word that would normally be used as its dictionary heading. For instance, three template classes for the English language are shown in FIGS. 4A, 4B and 4C, and the dictionary form in each of these classes is shown in italics.

The template classes are categories to which many individual templates may belong. A template includes a list of stems and a set of rules, one rule for each of the generated forms in the template class to which the template belongs. Rules may be blank, indicating that no form exists in the template for the generated form slot the rule is associated with. While template classes are concerned with the various types of inflectional forms that each part-of-speech as a whole is associated with, the templates contain information about the specific ways in which words belonging to a particular part-of-speech relate the different inflectional forms to each other. That is, any particular word belongs to some template, and that template, in turn, belongs to some template class.

Continuing with the example of English nouns mentioned above, a high level view of the hierarchical nature of the template classes and templates is shown in FIG. 4D. The node 304 in FIG. 4D labeled “noun” represents a template class, and the nodes 306, 308 and 310 represent templates corresponding to regular nouns, regular nouns that end in s, sh, ch or x and irregular nouns. Below each of the templates are examples of words which would be assigned to those templates in a lexicon. FIG. 4D shows that to handle the words “dog”, “dish”, “child” and “sheep” it makes sense to have three templates 306-310 belonging to the noun template class 304. The noun-regular template 306 handles nouns that add the suffix “s” in the plural. The noun-regular s.sh.ch.x template 308 handles a class of nouns that add the suffix “es” in the plural, and the noun-irregular template 310 handles all nouns that have some other relationship between the singular and plural forms. Templates 306, 308 and 310 are now more concretely defined in FIGS. 4E, 4F and 4G.

FIGS. 4E and 4F show that the first two templates 306 and 308 have a single stem, both of which are named “stem”, and FIG. 4G illustrates that the noun-irregular template 310 has two stems named “SingularStem” and “PluralStem”. This may be a common way in which templates are concretely defined. That is, templates meant to be used by morphologically regular words contain only one stem, because in order to be considered regular, all forms of a word must be able to be computed from a single piece of information (i.e., a single stem). Conversely, templates meant for morphologically irregular words include multiple stems, since irregular words, by definition, require more than one piece of information to compute all of their forms.

Below the notation of stems in FIGS. 4E-4G, the Figures show a list of generated form names which are inherited from the noun template class. Recall that the noun template class is shown in FIG. 4A. Next to each of the generated form names is a particular rule that specifies how to compute that associated generated form given a stem value. For instance, in the rule column, the numbers “(1)” and “(2)” are variables which refer to the list of stems. Therefore, where the number “(1)” is listed in the rule, that variable is simply meant to be replaced by the first stem value in the template, and the remaining characters are treated as prefixes or suffixes on those stem values.

A concrete example may assist in understanding. Assume that the stem value equals “dog” in the noun-regular template shown in FIG. 4E. The generated form “singular” has an associated rule “(1)”. This means that the singular form of the stem “dog” is simply the stem value “dog”. The rule associated with the “plural” generated form is “(1)s”. This means that the generated form simply takes the first stem value “dog” and adds an “s” to provide the plural generated form “dogs”, etc.

In accordance with another embodiment, a stem macro can be used so that second, third, . . . , nth stems can be derived by applying the rule to the first stem. For instance, a set of rules used in a template may fall into two or more classes where the “interior” of the rule is the same for each class and these “interiors” are related to each other in a deterministic way. In order to eliminate redundancy in the textual representation of the rules, a macro can be defined for each of the interiors. In one particular implementation this macro looks like a stem (it has a number and is referred to in the same way) but it is not an independent piece of information. Instead, it is related by rule to a “real”, independent stem. For example, assume the following is an abbreviated template:

1: Stem

(1)abc

(1)def

(1)xyz

(1)xyzghi

(1)xyzjkl

The stem can alternatively be expressed equivalently as

1: Stem

2: DependentStem=(1)xyz

(1)abc

(1)def

(2)

(2)ghi

(2) jkl

It can be seen that the stems are derived by referring to a rule and applying that rule to the stem.

In accordance with another embodiment, suggestions for other stem values are generated by associating with a stem one or more rules that are based on other stems. For instance, in the English verb-irregular template, there are three slots, one for the present verb stem (e.g., drink), one for the past tense (drank) and one for the past participle (drunk). It is often the case that the past tense and the past participle are the same (such as with bring-brought-brought), and when they are not the same there is often a “ . . . a . . . . u . . . ” relationship (such as with swim-swam-swum). These relationships can be embodied as rules applied to other stems to suggest likely values for stems. Suggesting likely values for stems helps the user's data entry flow.

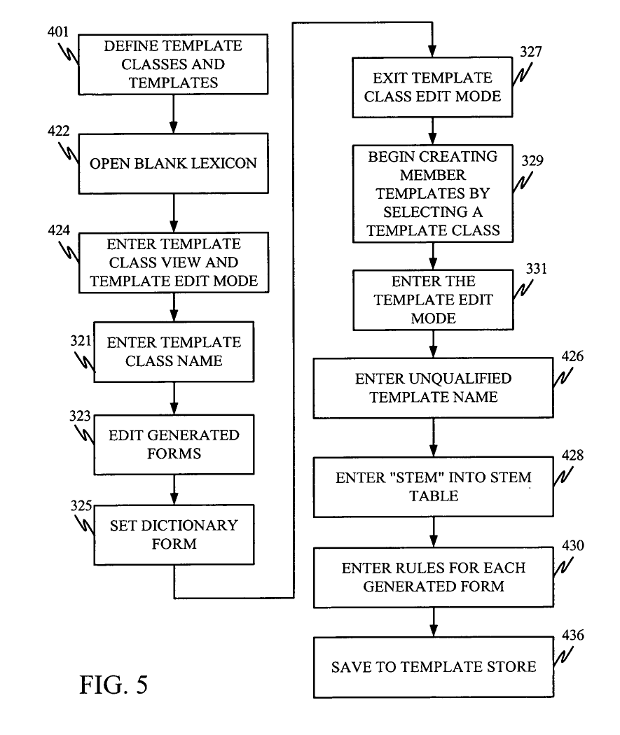

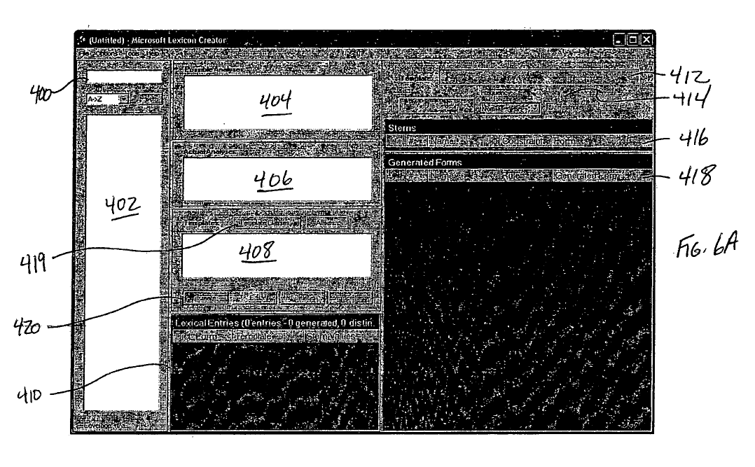

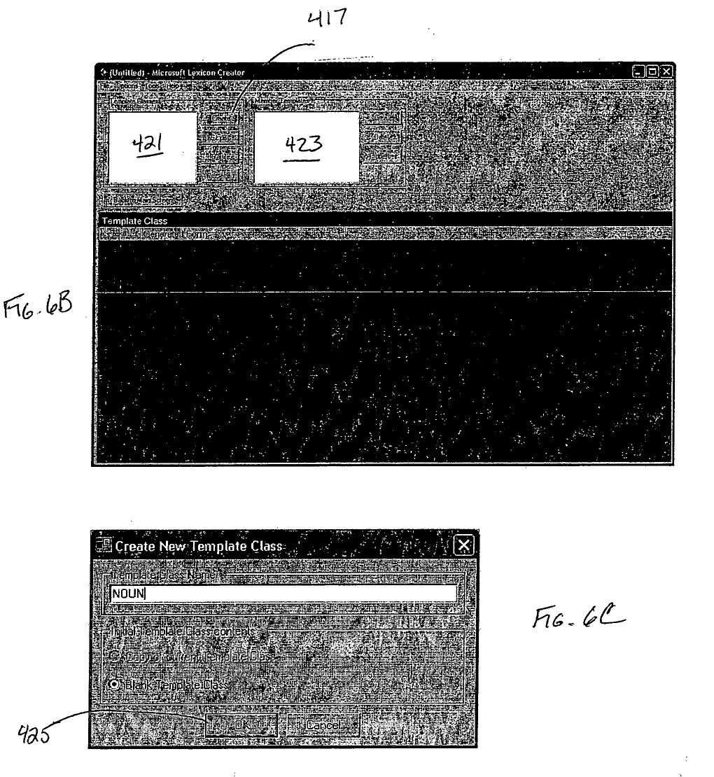

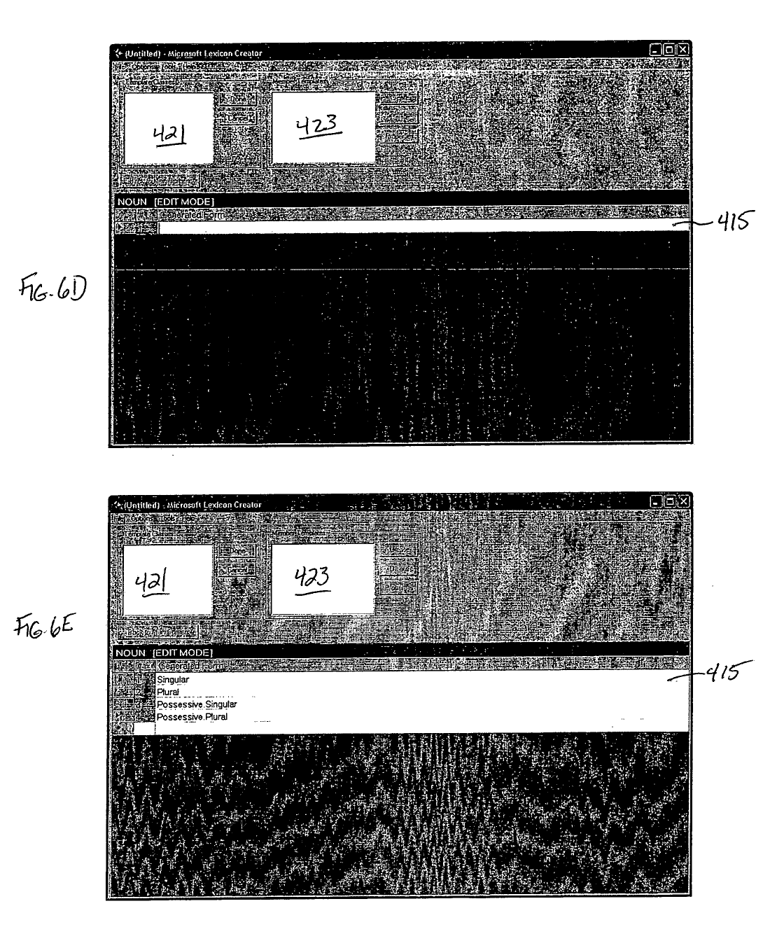

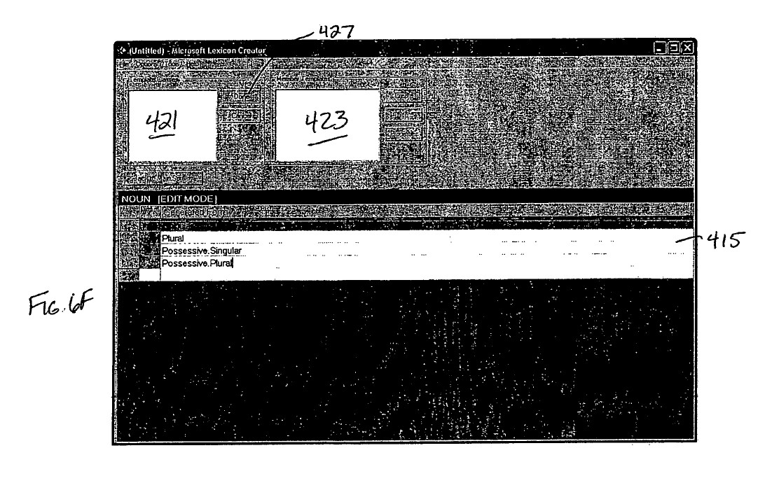

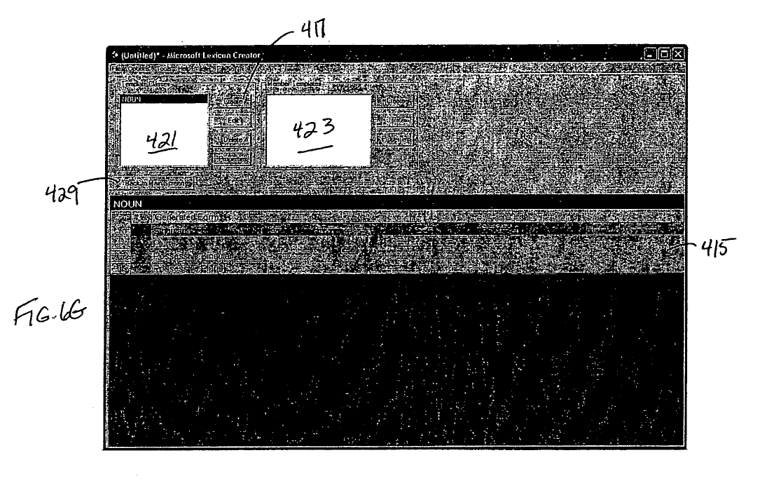

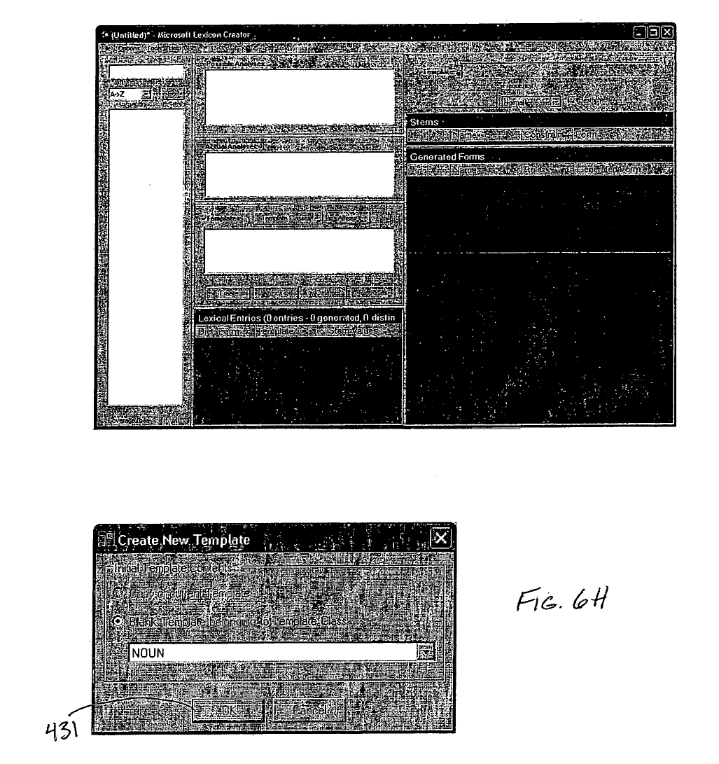

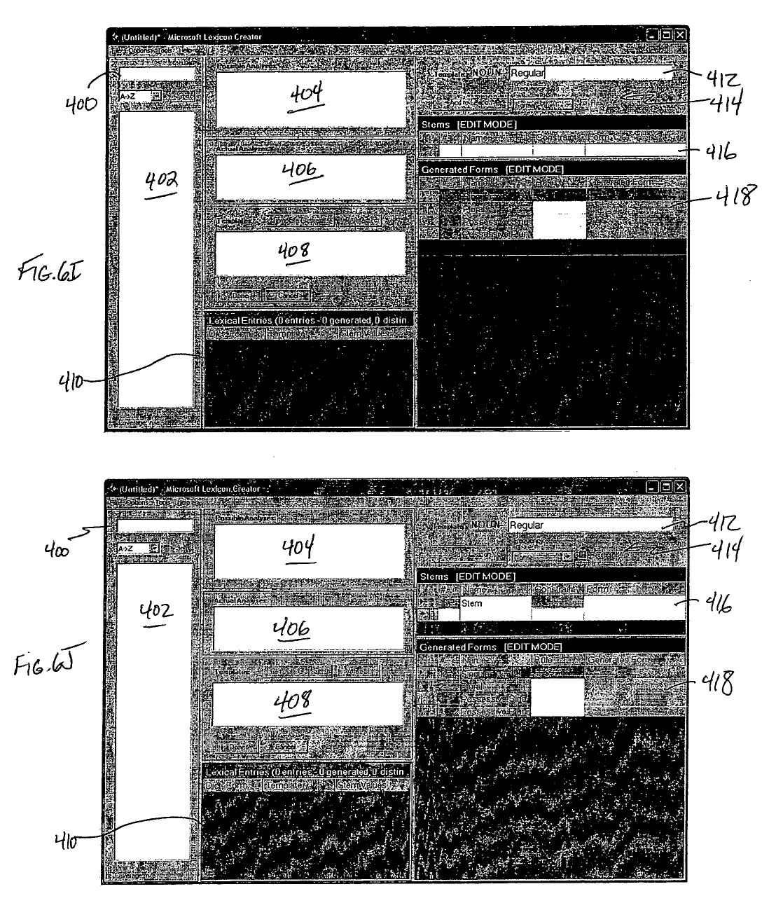

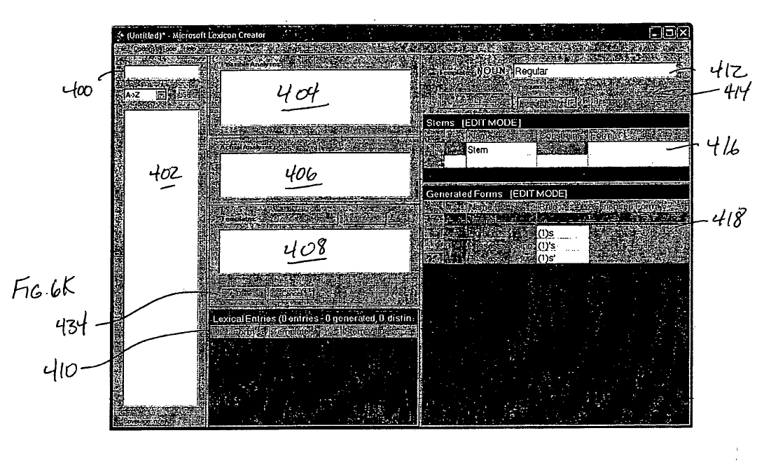

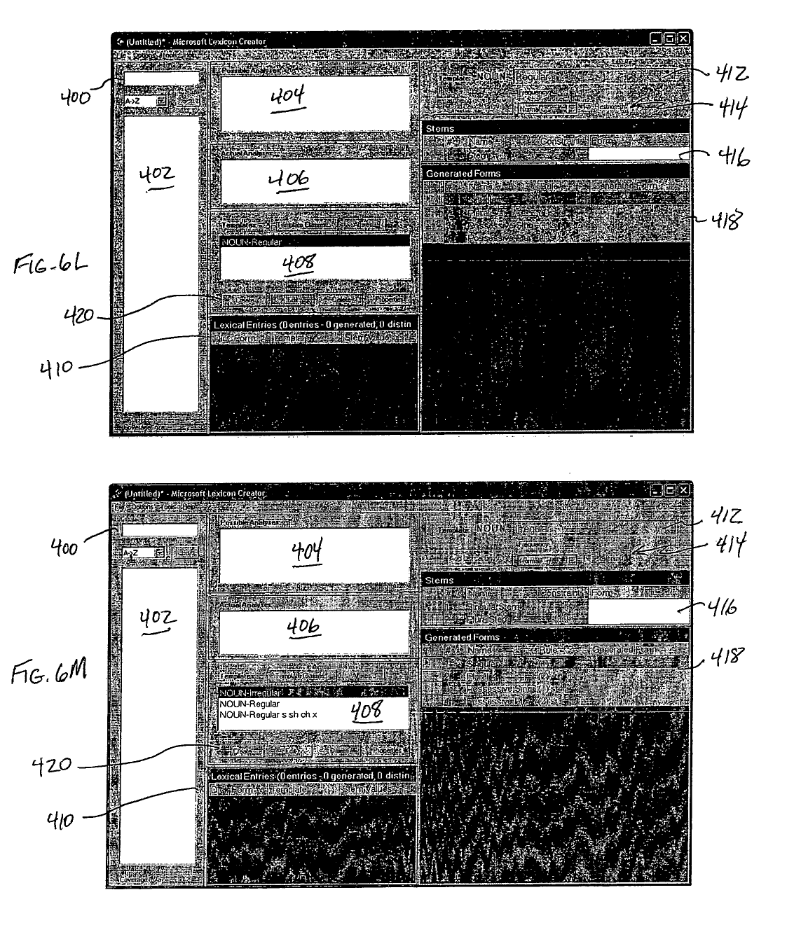

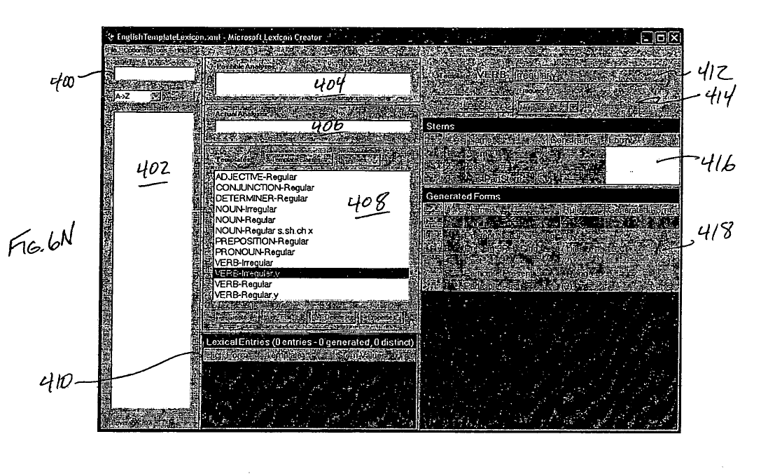

Once the template classes and templates are created conceptually, they are entered into system 200 shown in FIG. 2 through authoring interface 206 and template authoring component 234. They are then stored in template store 208. This is indicated in more detail below with respect to FIGS. 5 and 6A-6N.

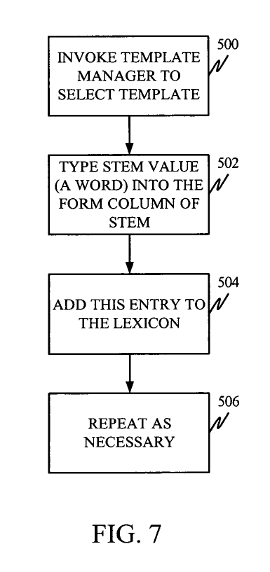

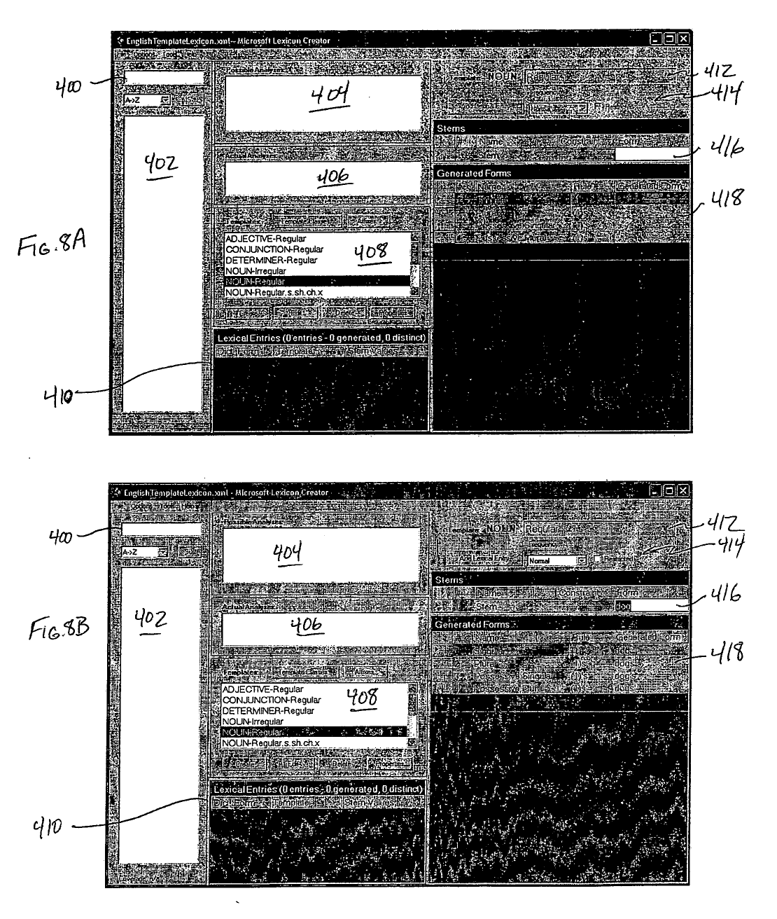

After the template classes and templates are stored in template store 208, the actual lexical entries are made. Entering the lexical entries is illustrated in greater detail below with respect to FIGS. 7-11E.

FIG. 5 is a flow diagram illustrating how the template classes and templates are entered concretely in the system 200 shown in FIG. 2. The present example continues by entering the noun-regular template shown in FIG. 4E.

The author first invokes template authoring component 234 which provides a display, (such as that shown in FIG. 6A), which represents a blank lexicon, in that there are no templates in the lexicon yet. The display shown in FIG. 6A includes a text entry box 400, a word list box 402, a possible analysis list box 404, an actual analysis list box 406, a templates list box 408 with associated control buttons, a lexical entries table 410, a template name box 412, a set of lexical properties 414, a stem value table 416 and a generated form table 418. The author then actuates the Template Classes button 419 to enter the template class view shown in FIG. 6B which displays template classes in box 421 and member templates in box 423. The author then clicks the Create button 417 in order to enter the template editing mode.

Defining the template classes and templates conceptually is indicated by block 401 in FIG. 5 and opening the blank lexicon shown in FIG. 6A is indicated by block 422 in FIG. 5. Actuating the Create button 417 in FIG. 6B to enter the template edit mode is indicated by block 424 in FIG. 5.

Entering the template edit mode illustratively causes template authoring component 234 to bring up a dialog box such as that shown in FIG. 6C. This allows the author to enter the name of the template class. By clicking Ok button 254, the author is allowed to edit generated forms for the named template class. This is indicated by block 321 in FIG. 5.

FIG. 6D is then displayed by template authoring component and the author enters or edits the names for generated forms for the noun template class in table 415. Names of some exemplary generated forms are shown in FIG. 6E. The author then sets the dictionary form, such as by right clicking on one of the generated forms and selecting an appropriate option from the resultant context menu. In the embodiment shown in FIG. 6F, the author has set the singular generated form as the dictionary form. Editing the generated forms is indicated by block 323 in FIG. 5 and setting the dictionary form is indicated by block 325.

The author then exits the template class edit mode by clicking the Done button 427. This is indicated by block 327 in FIG. 5 and results in template authoring component 234 providing a display such as that shown in FIG. 6G which shows that the template class “Noun” has been added to the template class list 421.

The next step is to create the three member templates of the “Noun” template class. Therefore, the author exits the template class view by clicking on the Back to Main Screen button 429. In one embodiment, member templates can be created from the template class view by clicking Create button 417, but the main screen is used to edit stems.

In any case, FIG. 6A shows the main screen. In one embodiment described herein, the author starts by creating the Noun-Regular template. The author clicks the Create button 420 in the templates box 408. Template authoring component 234 displays a dialog box shown in FIG. 6H which allows the author to choose the template class (or course, only one choice is provided in the example). The author clicks the OK button 431 to enter the template edit mode. Choosing the template class is indicated by block 329 in FIG. 5 and entering the template edit mode is indicated by block 331.

Once the template edit mode has been entered, template authoring component 234 provides a display such as that shown in FIG. 6I. The display is similar to that shown in FIG. 6A and similar items are similarly numbered. However, the control buttons associated with the templates table 408 have changed slightly to include a “Done” button and a “Cancel” button, the name box 412 has the template class name “Noun” filled in and the author is allowed to fill the remainder of the template name (e.g., “Regular”). Also, the stems table 416 and generated forms table 418 are now open text boxes and are indicated as being in the edit mode. The author first enters the unqualified template name (the part following the name of the template class) “regular”. This is indicated by block 426 in FIG. 5 and is shown in FIG. 6I. Next, the author enters a single row in the upper “stems” table 416 for the stem “stem”. This is indicated by block 428 in FIG. 5 and is shown in FIG. 6J.

The author then enters the rules associated with each generated form, in the generated forms table 418. This is indicated by block 430 in FIG. 5 and is shown in FIG. 6K. Finally, in one embodiment, the author can set a criticality indicator (not shown but which could simply be a check mark adjacent certain forms) to indicate that the specific form is crucial in identifying a particular template class. If one of these forms is found in the input list, it renders the job of finding a correct template much easier. The user then actuates the “Done” button 434. This saves the noun-regular template to the template list in templates table 408 which can then be saved to template store 208, and also exits the template edit mode. This is indicated by block 436 in FIG. 5 and is shown in FIG. 6L. It can be seen in FIG. 6L that the noun-regular template has been added to the template list in templates table 408.

Of course, the author can now enter the noun-regular.s.sh.ch.x and the noun-irregular templates by actuating the “Create” button 420, creating a new template. That template will inherit the generated form names from the noun template class and therefore the author simply needs to change the name, possibly the number of stems, and the rules associated with the generated forms. Once all of the templates have been added, template authoring component 234 provides a display such as that shown in FIG. 6M. FIG. 6M shows that the template list in template table 408 now includes all three templates.

FIG. 6N shows one illustrative template list for a sample English language lexicon in which a plurality of different template classes and corresponding templates have been created by the author through template authoring component 234.

Once the template classes and templates have been defined and created by the author through template authoring component 234, lexical entries can be made to create a lexicon. In other words, in one embodiment, words are assigned to (or linked to) templates to create the lexicon. Template manager 236 and lexical data manager 240 (shown in FIG. 3) are invoked by the author in order to retrieve templates, link them to words, and resave them. Lexical data manager 240 manages the entry of data into templates retrieved by template manager 236 and allows the author to see the lexical data, add or remove lexical entries in the lexicon and to add or remove associated attributes and rules in the templates. Of course lexical data manager 240 can be configured to provide any of a wide variety of other information or different information as well. For instance, lexical data manager 240 may be configured to allow the author to see who entered the information corresponding to an individual lexical entry, the date that the information was entered, or updated, notes/comments, etc. The lexicon may also include frequency information, style notes, usage notes, grammar, other notes, synonym links, pronunciation and stress information, syllabification and hyphenation points, etc.

In one illustrative embodiment, there are two ways in which the author can make lexical entries. The first is simply to invoke template manager 236 and lexical data manager 240 to retrieve a desired template, assign a word manually to the template, and then to restore the template. The second way is to use automatic template matching component 238. Both of these embodiments are described in greater detail.

As the discussion proceeds, it will be noted that it may be desirable to define all template classes and templates prior to entering lexical data. In practice, however, this may be very difficult and the author will likely notice missing templates or template classes or other problems with existing templates while making lexical entries. As will be described below, in accordance with one embodiment of the present invention, it is relatively easy to change templates and template classes without negatively affecting existing lexical entries that use those templates.

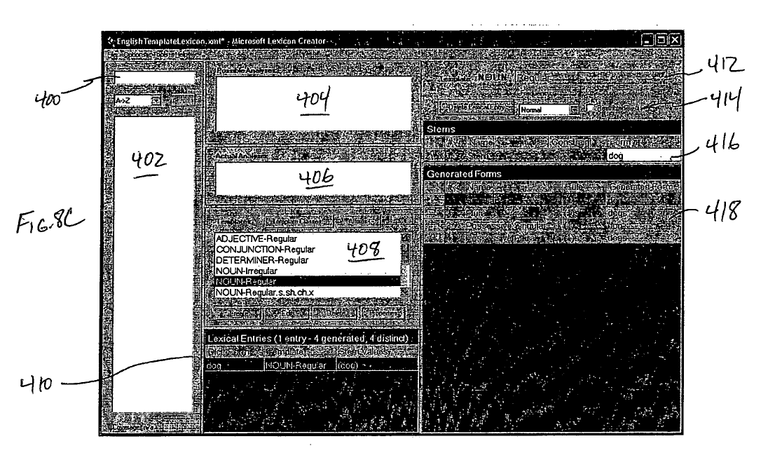

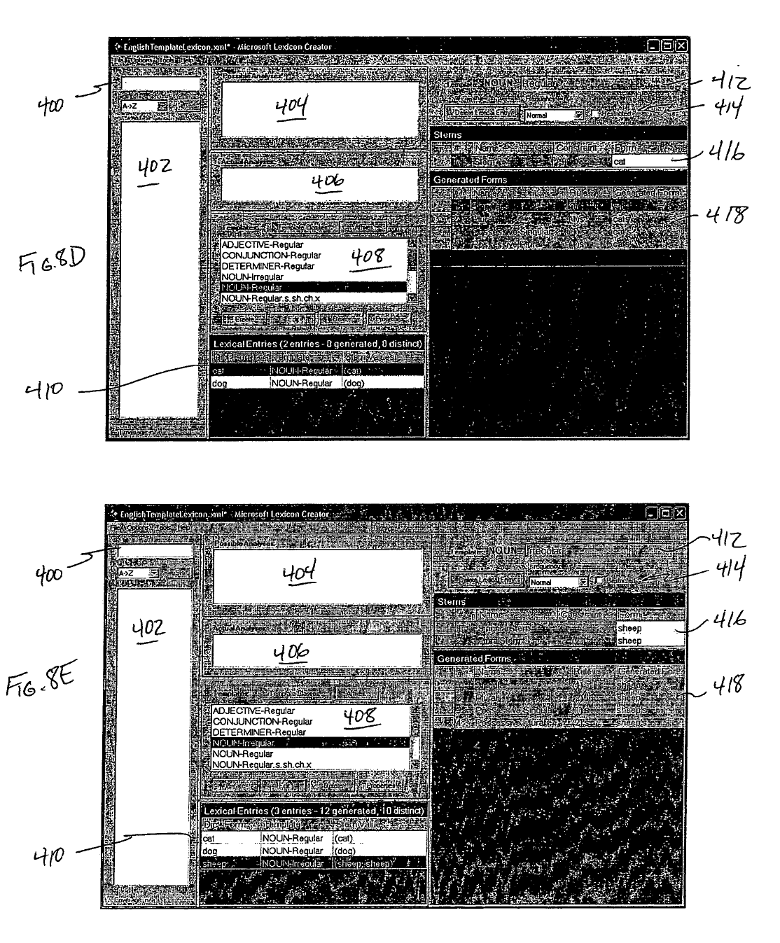

FIG. 7 is a flow diagram illustrating the method of making a lexical entry by choosing a template and entering a stem value (or linking a word to that template) manually. First, the author invokes template manager 236 to select a template. This is indicated by block 500 in FIG. 7. Continuing with the example mentioned above, assume that the author has selected the noun-regular template from the template list in the center of the display. This is indicated by FIG. 8A. Selecting this template displays the name, stems, generated forms and associated rules for this template on the right half of the display.

Assume further, for the sake of example, that the user wishes to enter the word “dog” into the lexicon. The author types the stem value “dog” into the form column in stem table 416. This is indicated by block 502 in FIG. 7. FIG. 8B shows that “dog” has been entered into the stem table 416. It will be noted that all of the inflectional forms of “dog” also appear in the generated form column of the generated forms table 418. This happens, of course, by applying the rules associated with each generated form in table 418 to the stem value “dog”.

At this point, the author can associate lexical data with this entry, other than that which has already been entered. For instance, in the embodiment illustrated in FIG. 8B, the user can set a “Restricted” flag on the lexical entry or set a frequency value by checking or selecting those values in lexical data indicators 414. In some applications which will use the lexicon being created, simply providing the word list is enough for the application to make adequate use of the lexicon. This may occur, for example, when the application is a spell checker. However, other applications may need more lexical information in order to perform well. In that case, various forms of data can be associated with each lexical entry. In one embodiment, this additional data can be associated with template classes, generated forms in template classes, templates a specific lexical entry, and rules in templates, and otherwise with specific lexical entries. This allows the user to implement a schema by using the attributes and values associated with a given lexical entry, template class, generated form, template, or rule, that makes sense for the user's application.

The two items of information associated with the lexical entry shown in FIG. 8B are the frequency of the lexical entry in the corpora from which the word list was obtained and whether the lexical entry is restricted. In one illustrative embodiment, the author can select whether the frequency was high, normal, or low and the user can either indicate that the lexical entry is restricted (meaning that it is vulgar or sensitive in some way) or unrestricted. A spell checking application might use this information to determine which words are safe to suggest as the correct spellings of misspelled words, for instance.

It will be appreciated, of course, that other lexical attributes can be assigned to a lexical entry, template, rule, etc., as well. For instance, it may be desirable to associate data indicating whether the lexical entry is a named entity (such as a proper name, a city name, etc.), the part-of-speech of the stem in a lexical entry, the pronunciation, information for certain parts of speech (such as typical subjects and objects of verbs, or grammatical structures—prepositions and particles—that occur around verbs), sense tagging to identify a specific sense of a word, domain encoding to indicate association of a use of a word and a given domain, translation information, examples of usage extracted from corpora, etc. Other attributes can be used as well.

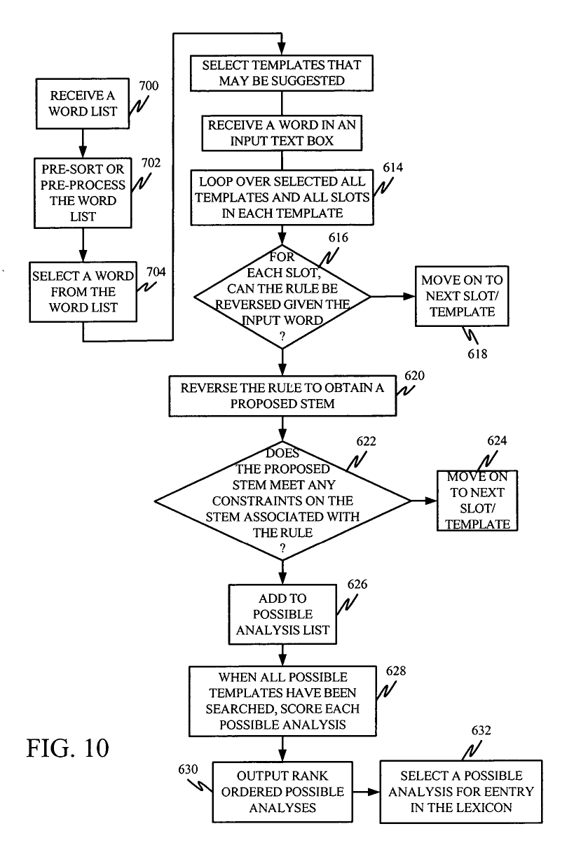

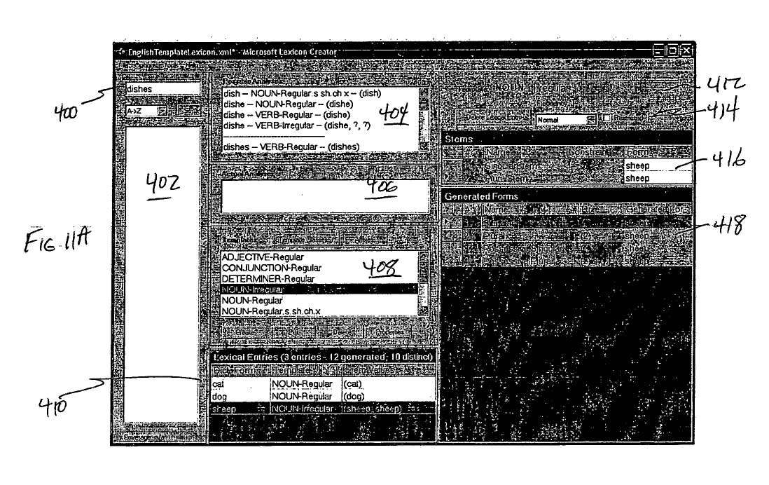

It will be noted that the author can also add constraints to the stem, under the “constraint” column shown in table 416. Stem constraints are simply regular expressions which can be set on the stem slots in table 416 so that a template is not proposed by the automatic template matching component 238 (described below with respect to FIG. 10) unless the stem constraint is met. This will be described in greater detail later in the specification.

In any case, once the necessary data is entered by the author, the author adds the lexical entry to the lexicon. This is indicated by block 504 in FIG. 7 and can be done, for example, by actuating the “Add Lexical Entry” button 506 shown in FIG. 8B.

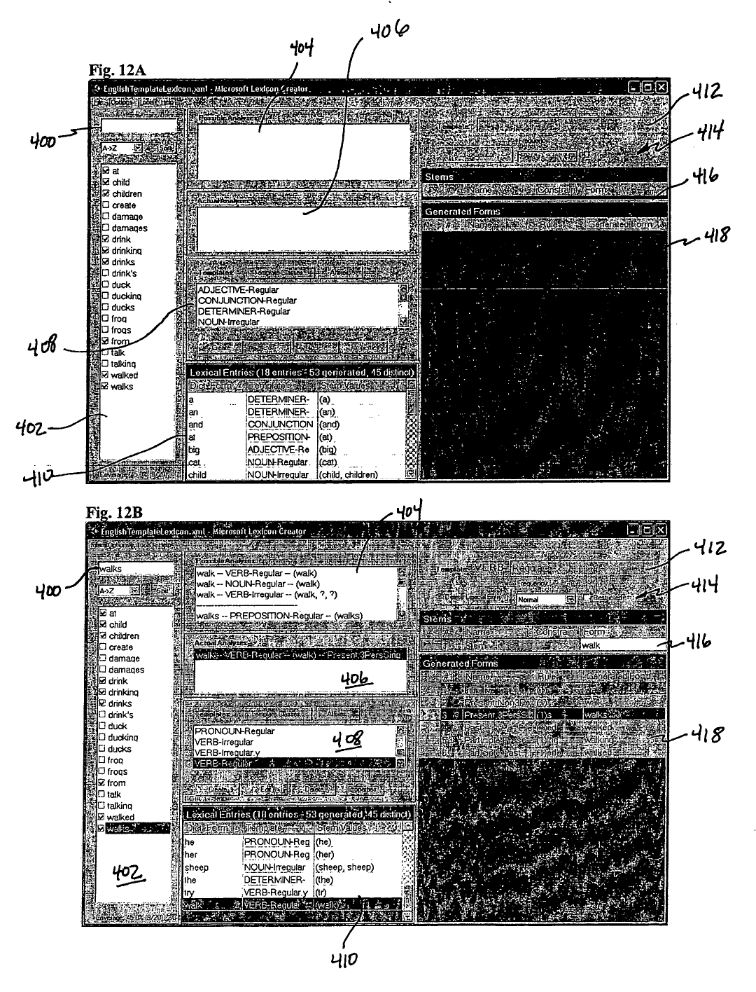

When the author has done this, lexical data manager 240 adds a new row to the lexical entries table 410 and changes the counts indicating the lexical entries in lexical entries table 410. This is illustrated in FIG. 8C. It can now be seen that lexical entries table 410 includes the statement “1 entry-4 generated, 4 distinct”. This means that there is one lexical entry in the lexicon in the formal sense discussed above (i.e., a template paired with a set of stem values constitutes a lexical entry), but there are four generated forms, of which all four are distinct. That is, one lexical entry “dog-noun-regular-(dog)” corresponds to four individual, distinct words, dog, dogs, dog's, and dogs'. Also, as described below with respect to FIGS. 12A and 12B, if the input is a wordlist check marks are placed adjacent any inflected forms found in the list.

The author then repeats these steps, as necessary, for all desired lexical entries. This is indicated by block 506 in FIG. 7. For instance, if a second entry is added for the word “cat” lexical data manager 240 updates the lexicon with that entry, and the counts in table 410 increase to 2 entries-8 generated forms and 8 distinct words. This is illustrated in FIG. 8D.

For an irregular word such as “sheep” the author enters multiple stem values in stem table 416. For instance, the author first chooses the noun-irregular template and enters the necessary stem values in table 416 and then adds the word to the lexicon. Once this has been done, lexical data manager 240 updates the lexicon as illustrated in FIG. 8E.

It will be noted that the “lexical entries” count is now 3-12-10 because, although there are twelve generated words (three noun lexical entries, and four generated forms per template), two of those words are the same—“sheep” and “sheep's” are both in the list twice. Therefore, it can be seen that depending on the form of the lexical entries that are entered, the number of distinct generated forms may be lower than the total number of generated forms, and will never exceed the total number of generated forms.

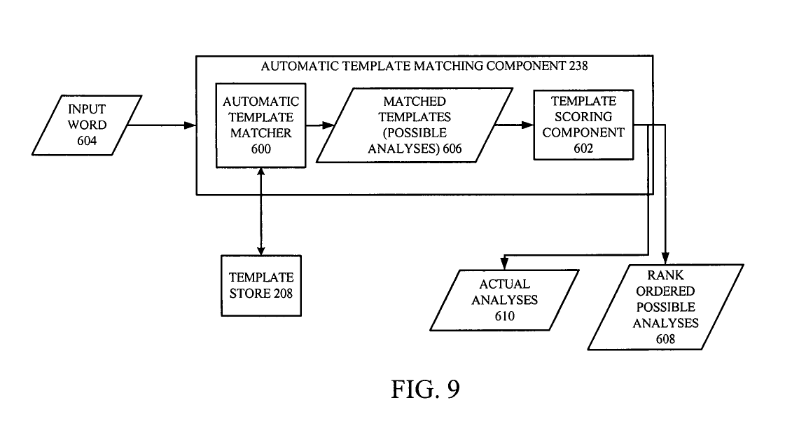

It can be seen that while choosing a template and entering stem values by hand certainly works to build a lexicon in accordance with the present invention, it may be relatively tedious and slow. Therefore, in accordance with another embodiment of the present invention, automatic template matching component 238 is configured to receive a word and match it against one or more templates to which the word most likely belongs. FIG. 9 is a block diagram illustrating automatic template matching component 238 in greater detail.

Automatic template matching component 238 illustratively includes automatic template matcher 600, and template scoring component 602. FIG. 9 shows that automatic template matching component 238 is configured to receive an input word 604, automatically match the input word 604 to one or more templates from template store 208 and provide a set of matched templates (each of which yields a possible analysis) 606 to template scoring component 602. Template scoring component 602 then scores the possible analyses 606 and provides, at its output, a rank ordered list of possible analyses 608, as well as any actual analyses, if applicable.

FIG. 10 is a flow diagram illustrating the operation of automatic template matching component 238 in accordance with two embodiments of the present invention. In the first embodiment which will be discussed, the user simply enters input word 604 into text box 400 and automatic template matching component 238 matches templates to that word. In accordance with the second embodiment discussed, an entire word list is input and the author selects one of the words in the word list for input to automatic template matching component 238.

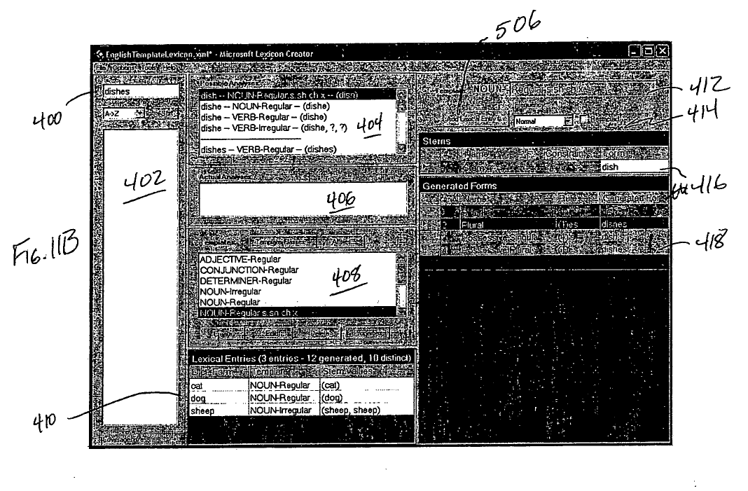

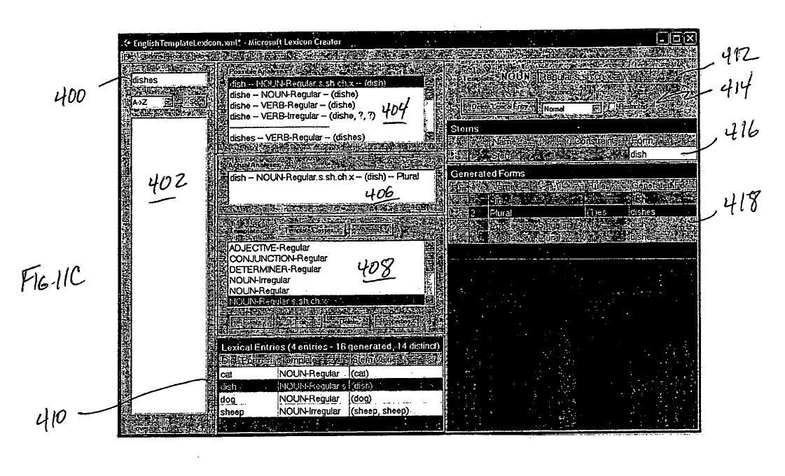

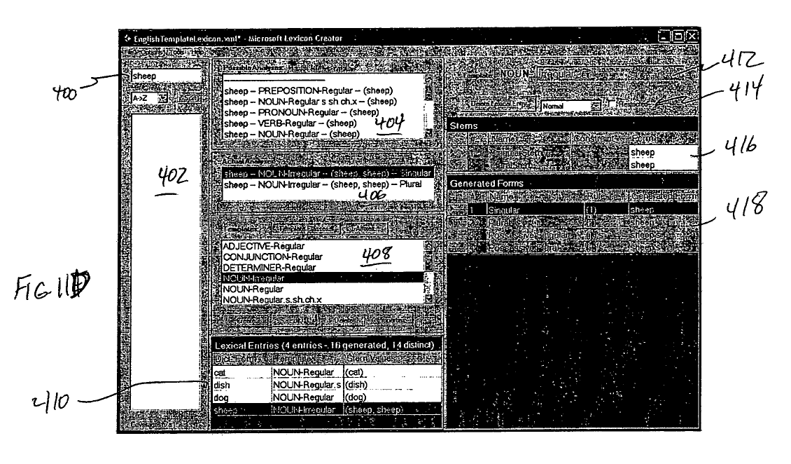

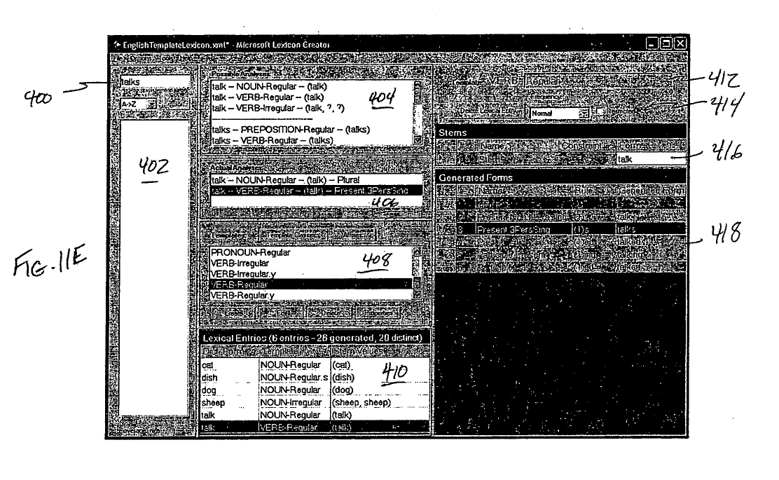

In accordance with the first embodiment, the user simply enters a word to be matched against the templates into a text box, and automatic template matching component 238 receives the word. This is indicated by block 612 in FIG. 10. For instance, FIG. 11A shows that the author has entered the word “dishes” into text box 400. FIG. 11A also shows that automatic template matching component 238 has identified and displayed a plurality of different possible analyses in the possible analyses table 404. In order to do this, automatic template matching component 238 first identifies which templates may be suggested. The templates can optionally include a flag which determines whether they can be automatically suggested. This flag can normally be set to true, but for very rare or specialized templates, it can be set to false. Selecting suggestable templates is shown at block 613 in FIG. 10.

Automatic template matching component 238 then loops over all selected templates stored in template store 208, and over all slots in each of those templates, in order to determine whether the input word matches any of the slots in any of the templates. This is indicated by block 614 in FIG. 10.

In performing this exhaustive search, automatic template matcher 600 asks two questions. The first is whether, for each slot in each template, the associated rule can be reversed given the input word. This is indicated by block 616 in FIG. 10.

For example, assume that the input word is “breathes”. Further, assume that the template being considered is the “verb-silent e” template. Assume also that the generated forms and rules for the “verb-silent e” template being considered by automatic template matcher 600 are as follows:

| | |
|---|---|
| Present.Non3PersSing | (1)e |
| Present.3PersSing | (1)es |
| Participle.Present | (1)ing |
| Past | (1)ed |

Automatic template matcher 600 first considers the rule associated with the first generated form. Since the input word “breathes” does not end in “e”, then this rule cannot be reversed given the input word. Therefore, for the first generated form, the answer to the question asked at block 616 is no. Thus, automatic template matcher 600 determines whether there are any additional slots in the template being considered and, if so, moves on to the next slot. This is indicated by block 618 in FIG. 10. Automatic template matcher 600 then asks the same question given the next slot; that is, whether the rule associated with that slot can be reversed given the input word.

Automatic template matcher 600 thus asks this question of the next generated form and associated rule. Since the input word “breathes” does end in “es”, the rule associated with the second generated form (which indicates that “es” is to be added onto a stem in order to obtain the third person singular form of the word) can be reversed. Therefore, the answer to the question asked at block 616 in FIG. 10 is yes with respect to this rule slot.

Since the answer is yes, automatic template matcher 600 reverses the rule to obtain a proposed stem, given the input word. This is indicated by block 620 in FIG. 10. By reversing the “es” rule on the input word “breathes”, automatic template matcher removes “es” from “breathes” to obtain a proposed stem “breath”.

Even though the rule in the third person singular slot can be reversed, that does not mean that the template under consideration (verb-silent e) should be provided as a possible analysis yet. That is because simply finding that the input word can possibly fit into a slot of a template does not provide enough information to make a possible analysis. A possible analysis is an entire lexical entry which includes both the choice of a template and the choice of a particular word to put into the stem values in that template.

As mentioned earlier with respect to FIGS. 4A-4G each rule has an associated number in parentheses, and that number identifies the particular stem in the stem table 416 with which the rule is associated. Assume, for the sake of the present example, that the “verb-silent e” template under analysis includes the following entry in the stem table 416:
(1) stem .+<:cons:>

This indicates that a constraint is placed on the first stem value. The constraint is indicated by the “.+<:cons:>” term. The “.+” portion of the constraint represents any non-empty string and the <:cons:> indicates that the first stem value must end in a consonant.

Automatic template matcher 600 then asks the question whether the proposed stem value derived by reversing the rule in the matched generated from slot meets any constraints on the stem associated with that rule. This is indicated by block 622 in FIG. 10. Since the proposed stem derived by reversing the rule is “breath”, and since the proposed stem ends in “h” which is a consonant, then the proposed stem does in fact meet the constraints placed on the stem “(1)” associated with that rule. Therefore, the answer at block 622 in FIG. 10 is yes. If the proposed stem did not meet those constraints, the answer would be no and automatic template matcher 600 would move to the next slot or template as indicated by block 624.

However, because in the present example, the constraint is met, then automatic template matcher 600 adds the template under analysis to the possible analysis list (or list of matched templates) 606. This is indicated by block 626 in FIG. 10.

When all of the templates and all slots for each template have been searched, a full list of possible analyses 606 will have been generated from automatic template matcher 600. However, in any given set of templates in template store 208 which have been defined by an author, a relatively large number of them will likely contain rules that pass through input strings unchanged and therefore place no constraints on possible outputs. Further, a large number of them will likely have no, or very weak, stem constraints. Therefore, to the extent that these templates exist, they will be considered as possible analyses and the possible analysis list in possible analyses table 406 will be flooded with possible analyses that likely will not apply to the given input word.

Therefore, the present invention also illustratively provides template scoring component 602 in automatic template matching component 238. Template scoring component 602 illustratively scores each of the matched templates to indicate how likely the possible analysis associated with each matched template is to be a correct analysis. This is indicated by block 628 in FIG. 10. It will be noted that a wide variety of different scoring techniques can be used, and the actual score can be displayed to the author through authoring interface 206, or the possible analyses can simply be listed in rank order, or both.

In one illustrative embodiment, template scoring component 602 uses three different factors in scoring each proposed analysis. The first is the amount of modification required to translate the input word back into the corresponding stem form. In other words, this factor identifies the amount of modification represented by the rule used to transform the input word into the corresponding stem value. It is believed that, if there is more modification required to transform the input word into the stem value, that tends to mean the rule being reversed is a more sophisticated and specialized rule. Therefore, if it actually does apply to the input word, it is more likely to be correct than a rule which requires very little modification of the input word.

In order to measure the amount of modification required, any conventional means can be used, and the present invention illustratively uses a measure indicative of edit distance between the input word and the stem, after the rule is applied. A bonus is added to the score for this possible analysis if the edit distance is non-zero. (The edit distance will be zero for rules such as “(1)” which do not transform the stem at all.)

A second factor that may illustratively be used to score possible analyses is based on whether the possible analysis has more than one stem associated with it. In one illustrative embodiment, if the possible analysis does have more than one stem associated with it, a penalty is applied to the score for that template. If more than one stem is required to describe a word, it is likely to be an irregular word and therefore it is less likely to occur than a regular word.

In English, for example, irregular forms include “buy/buys/buying/bought/bought” and “fight/fights/fighting/fought”. Each of these forms requires two stems (buy and bought; fight and fought) because the author must explicitly set out what the these stems are since it cannot be predicted from the singular. It is likely that these irregular, multi-stem templates will apply to a relatively small subset of words, and therefore a penalty is applied to those templates when they are suggested as possible analyses.

It will be noted that each of the factors used by template scoring component 602 can be weighted and the weights can be empirically determined or user defined. In one illustrative embodiment, the weight associated with the penalty for having more than one stem can be overcome by the bonus associated with the edit distance, if the edit distance is very large (such as adding 4-5 characters, for instance). This means that if the rule requires 4 or 5 characters to be removed from the input word in order to obtain the stem, it is likely a correct analysis even if it is irregular. In addition, in one embodiment, the author can be provided with a plurality of selectable scoring options. Of course, other weighting schemes can be used as well.

In accordance with another embodiment of the present invention, a third factor used in scoring each possible analysis is based on whether siblings (other generated forms from the template of the proposed analysis) are actually found in the input word list. In other words, if one of the rules generates a hypothetical word that is actually found in the input word list (inputting and processing of an input word list is discussed below) this provides a bonus for the possible analysis. For instance, assume again that the input word is “breathes”. The generated forms will likely be “breathe” “breathes” “breathing” and “breathed”. Assume also that the input word list has the words “breathe” and “breathing”. Then, this possible analysis will get a bonus for each of those generated forms because they are found in the word list. Assume further that the input word list does not include the form “breathed”. This does not necessarily mean that the possible analysis is incorrect, but may simply mean that the word list is incomplete. Therefore, the more data that is input to the system, the better performance may be achieved by automatic template matching component 238.

However, a complete absence of siblings in the input word list may indicate that the possible analysis is incorrect. Assume for example that a possible analysis for a verb “walk” is identified in a regular template “verb-regular”, and that the generated forms and rules associated with the generated forms are as follows:

| | |
|---|---|
| Present.Non3PersSing | (1) |
| Present.3PersSing | (1)s |
| Participle.Present | (1)ing |
| Past | (1)ed |

It can be seen that the verb “breathes” will still match this template because it matches the third person singular form. The input word ends in “s” and it goes back to the proposed stem “breathe” upon reversing the third person singular form rule. (This assumes that stem 1 has no stem constraint or has a stem constraint satisfied by “breathe”.) However, all of the siblings will be incorrect. For instance, applying the Participle.Present rule to the proposed stem would result in the word “breatheing”, and applying the Past form rule would result in the word “breatheed”, neither of which are correct. Therefore, if none of the generated siblings are found in the input word list, the possible analysis may well be incorrect.

Another factor which can be considered in scoring a possible analysis is frequency information. Some input word lists may have frequency associated with each entry in the word list. The frequency is indicative of how often the given word is found in the corpus from which the word list was extracted. This indicates which words are common and which are uncommon. The template scoring component 602 can apply a number of different rules, using frequency information, to score each possible analysis. For instance, assume there are four generated forms associated with a possible analysis and two of the generated siblings are in the word list and have a large frequency (for instance, in the “breathes” example discussed above, the siblings “breathe” and “breathes” would both be found in the word list and may be relatively high frequency).

However, assume some of the siblings have zero instances occurring in the input word list (again, using the “breathes” example mentioned above, the terms “breatheed” and “breatheing” have zero instances in the word list). This is good evidence that the possible analysis is incorrect. It is likely that (in this example which is in the English language and assumes a relatively large input word list) if some of the siblings are very common in the input word list, all of them will at least be present. Therefore, if some of the siblings are very common in the input word list but some of them are completely missing from the input word list, then a penalty maybe applied to that possible analysis. Of course, this scoring component may be omitted when processing languages such as Finnish with vast numbers of generated forms per template.

Other scoring techniques can be used as well. For instance, a “restrictiveness score” can be added to the regular expressions that serve as stem constraints, and possible analyses that involve proposed stems that satisfy stem constraints are awarded bonuses proportional to this restrictiveness score. So even a possible analysis that arises from a content-free rule like “(1)” might get a high score if stem 1 has a very specific constraint that is satisfied by the proposed stem.

In other words, a rule effectively contains the stem constraint as a subpart, and there can be a global score for how likely a given word is to be a possible output of that rule. Satisfying the stem constraint can be as much a part of this as satisfying the other requirements in the rule and successful possible analyses can be awarded points accordingly.

Again, it is worth noting that template scoring component 602 can score the possible analyses using these, different, or additional factors, as desired by the user. Outputting the rank ordered possible analyses 608 is illustrated by block 630 in FIG. 10.

FIG. 11B illustrates that automatic template matching component 238 has output a plurality of possible analyses in the possible analysis table 404 associated with the input word “dishes”. Each of the possible analyses has been scored and the “dish—noun-regular.s.sh.ch.x—(dish) possible analysis was scored the highest. Template scoring component 602 can also use a scoring threshold and indicate which of the possible analyses have scores that exceed the threshold level. For instance, the horizontal line in the possible analysis table 404 indicates that the four possible analyses above the line exceed a scoring threshold and are likely to be promising while any possible analyses below the line are only “possible”.

By selecting any of the possible analyses in the possible analysis table 404, lexical data manager 240 displays the full analysis proposed by automatic template matching component 238. FIG. 11B illustrates that the first possible analysis has been selected and the entire analysis is now shown. FIG. 11B also illustrates that not only are the template name and stem values for the word shown, but also the input word is highlighted where it occurs in the generated forms table 418. In the example shown in FIG. 11B, the word “dishes” is highlighted as the proposed plural of the form “dish”. Of course, this is correct, and the user simply actuates the “Add Lexical Entry” button 506 to add the possible analysis to the lexicon. The results of adding the possible analysis to the lexicon are shown in FIG. 11c. Selecting a possible analysis for entry into the lexicon is indicated by block 632 in FIG. 10.

It can be seen that the next time the user enters “dishes” into the text box 400, not only will automatic template matching component 238 output the rank ordered possible analyses 608 in the possible analysis table 404, but it also outputs an actual analysis 610 in the actual analyses table 406. Because an actual analysis appears in actual analysis table 406, the user knows that this word is already in the lexicon for some part of speech (which is visible from the actual analysis template name).

By selecting the entry in the actual analysis table 406, lexical data manager 240 displays the various ways in which the input word has already been matched in the lexicon. In this case, “dishes” only matches in one way as shown in FIG. 11C. However, the word “sheep” fits in two ways, as is illustrated in FIG. 11D.

It may be more common, however, to find that rather than finding a word that matches the same lexical entry twice, the word may actually match two or more different lexical entries. For instance, assume that the input word is “talks”. If this word has already been properly entered into the lexicon, it will appear as a “verb-regular” analysis (as in “he talks a lot”) and also as a “noun-regular” analysis (as in “I went to five talks at the conference.”) FIG. 11E illustrates just such a case in which a more typical list of actual analyses are shown in actual analyses table 406.

Recall that FIG. 10 also shows a different way in which words can be entered into automatic template matching component 238. Instead of simply typing an input word 604 into text box 400, the user may wish to enter an entire word list 224, shown in FIG. 2) into lexicon creation component 204. In that case as described with respect to FIG. 2, word list creation component 202 has access to text corpora 220, existing dictionaries 222, n-gram frequency information that indicates context, or other corpora and uses known techniques for deriving word list 224 from those sources. Alternatively, a user can type in word list 224 using a manual entry component 226. In any case, lexicon creation component 204 receives the word list. This is indicated by block 700 in FIG. 10. FIG. 12A illustrates the display showing that an input word list is provided in word list pane (or box) 402, after a number of templates have already been created. The words that already exist in the lexicon are indicated by a check mark being placed adjacent them in the word list box 402.

After the word list is received, lexicon generator 226 can use sort and grouping utilities 230 or other input data analysis utilities 232 (shown in FIG. 3) to process the word list. Pre-sorting and pre-processing the word list is indicated by block 702 in FIG. 10. A number of common techniques for sorting or otherwise pre-processing or analyzing the input word list can be used. For instance, the words can simply be sorted alphabetically, or they can be sorted from the end of the word alphabetically (by endings), they can be sorted by frequency of appearance in the corpora from which they were extracted (if that data is available). These types of sorting and grouping utilities are illustratively provided by block 230 shown in FIG. 3. They provide means by which the word list can be managed and navigated and presented to the remaining portions of lexicon generator 226, as desired.

In addition, the other input data analysis utilities 232 may include such things as language dependent heuristics which can be run on the word list. For instance, assume that the word list not only contains a list of words, but also multi-word expressions (such as phrases and idiomatic expressions) and semantic information derived from the corpus from which the words where extracted. One heuristic employed by block 232 may include, for instance, sorting the word list into all words that followed the word “the” in the corpus from which they were extracted. This can be applied, for instance, if the author wishes to concentrate on entering nouns and adjectives into the lexicon. It is quite likely that if the input word in the word list followed the word “the” as it was used in the text corpus from which it was extracted, it is very likely to either be a noun or an adjective. Other heuristics can be employed as well, of course, and this is only by way of example.

In addition, presort and preprocessing of the word list can be done by automatic template matching component 238. For instance, as described above with respect to FIG. 10, automatic template matching component 238 provides a score indicative of how likely any given word matches a given possible analysis. Each of the words in the word list can be provided to automatic template matching component 238 and then sorted in the input list based on the scores calculated by template scoring component 602. This indicates which words in the word list likely fit into an already-defined template in template store 208.

In any case, once the word list has been received and it has been pre-sorted or pre-processed or otherwise analyzed (if desired), words in the word list can be quickly assigned to templates instead of typing a word into text box 400, the user simply selects one of the words in the word list (such as by clicking on it). This is indicated by block 704 in FIG. 10. An example of selecting a word is shown in FIG. 12B.

FIG. 12B illustrates that the word “walks” has been selected. A number of possible analyses are provided in possible analysis table 404, as is one actual analysis in table 406. The templates are listed in template table 408 and the lexical entries are shown in lexical entry table 410. The template name of the highlighted template is shown in name box 414, the stems are shown in stem table 416 and the generated forms, rules and names are illustrated in table 418.

A number of other things should be mentioned with respect to the present invention. First, the present invention will illustratively enable description and linking of complex morphological phenomena in a relatively simple and intuitive way. This can be done by extending the hierarchical nature of the template classes and templates discussed above. In this embodiment, the rows (such as rows defining rules and generated forms) in the template are hierarchically arranged. One row is deemed to be a child of a parent row (or a descendent row is a child of an ancestor row) if it contains everything in the ancestor plus something else.

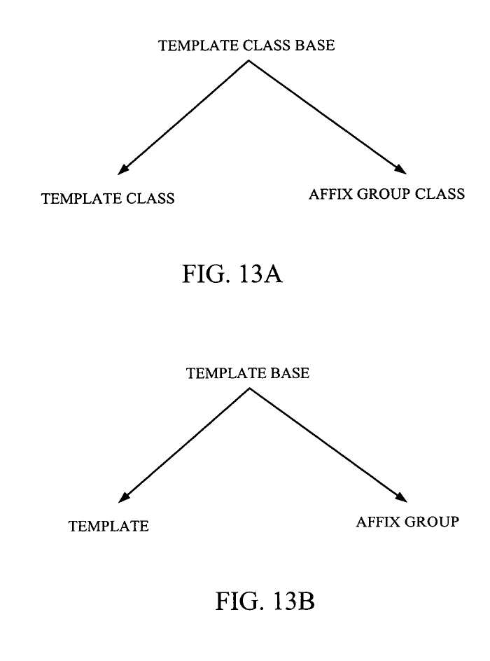

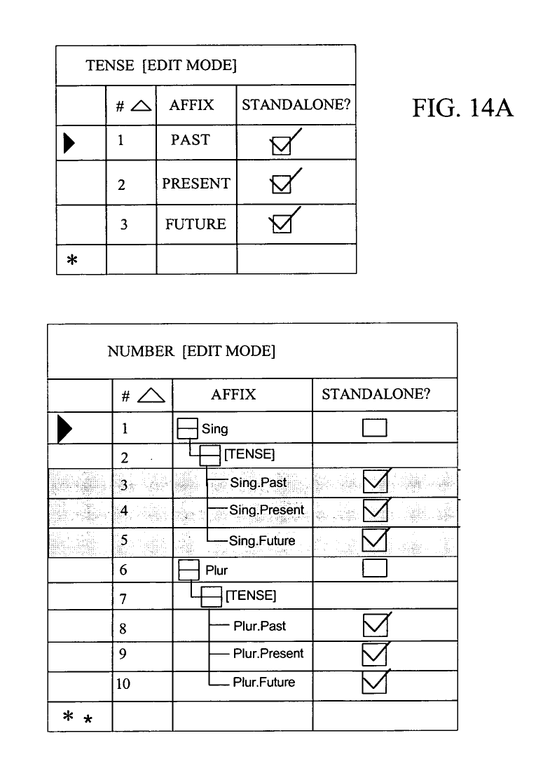

This simplifies representation of words in languages that allow multiple affixes, one added to the next, at the end of a word for example, or circumfixes (where the stem has a prefix and suffix) In addition, information can be accommodated and other morphology affixation as well. If a hierarchical representation of the affixes was not allowed, the system would have to represent the templates as thousands of separate rows. However, by allowing the rows to be represented hierarchically, the hierarchical tree is able to represents all combinatorial possibilities of the affixes much more efficiently and simply. FIGS. 13A-21 set out one embodiment of hierarchical representation of affixes in more detail.

More specifically, by representing each affix as a separate data structure an author can build up structured templates that encode all possible affix combinations without having to enter and maintain multiple copies of the same information.

Two data types can be used to implement this: affix group and affix group class. These are directly parallel to the previously discussed template and template class data types, with only a few small differences. They can be viewed in terms of inheritance as shown in FIG. 13A.

Assume a template class base has the following properties: a name, and a tree of generated form slots. In addition, assume a template class has a dictionary form index.

An affix group class, on the other hand, has no extra properties. It does have an extra capability, however. It can be embedded in the generated forms tree of some other template class base, while template classes cannot.

Assume further that a template base (shown in FIG. 13B) has the following properties: it belongs to (is a member of) some template class base, it has an “unqualified name” (such as “Regular”) which, when combined with the name of the template class base it belongs to (such as “NOUN”), gives the “full name” (“NOUN-Regular” in this case.), and it has a tree of rules corresponding in structure to the generated forms tree of its template class base.

In addition, assume that a template has a set of one or more stems.

A template must belong to a template class. An affix group, on the other hand, has no extra properties. It does have an extra capability, however—it can be embedded in the rules tree of some other template base, while templates cannot. An affix group must belong to an affix group class.

There are two other important differences between templates and affix groups. First, lexical entries can belong to templates but they cannot belong to affix groups. Second, the rules in templates must make reference to one of the template's stems. The syntax of a template rule is, then, prefix(function(stem))suffix, where any of prefix, function and suffix may be null. (When function is null there is only one set of parentheses.) Examples include (1), (1)ed, pre(2), un(Transform(1))ing. Since affix groups do not have stems, rules in affix groups naturally cannot make reference to stem numbers. Affix group rules are also prohibited from using functions. The syntax is, then, prefixosuffix, where either or both of prefix and suffix may be null. Examples include: ( ), ( )ed, pre( ), un( )ing.

As mentioned above, primary distinction between template classes and templates is that template classes encode the “what” (which slots in a morphological paradigm are logically present) and templates encode the “how” (how specific word forms to fill those slots are computed). This extends to affix group classes and affix groups—affix group classes capture the “what” (which affixes are being treated as one logical unit) while affix groups capture the “how” (how those affixes are realized in different environments).

In one embodiment, an important difference between template (classes) and affix group (classes) is that template (classes) are inherently independent and can meaningfully stand on their own, while affix group (classes) are inherently dependent and are made fully concrete only in the context of how they are referenced. This is reflected most clearly in the differences in rule syntax above—template rules have an explicit input (the stem value), while affix group rules do not. As we'll see below an affix group rule is “attached” to some other rule, meaning that the output of that rule will implicitly become the input of the affix group Rule (and fill the “( )” placeholder).

The formal structure of the generated forms trees of template classes and affix group classes and the rules trees of templates and affix groups will now be described.

First note that a tree of depth one is equivalent to a list. All “flat” templates are therefore already degenerate “structured” templates (meaning that the affix-related features strictly add functionality rather than change existing functionality). Generated forms trees are the primary type of tree. (Rules trees are secondary since they cannot have their structures edited independently of the generated forms trees they reflect).

Any given template class base (i.e., either a template class or an affix group class) has a set of generated form nodes. These are the top-level nodes in the generated forms tree. Each node has a name, a flag indicating whether the node is “standalone” (which is described below), and zero or more children of type affix group class. As a concrete example we can examine the affix group classes tense and number. Templates for these classes are shown in FIGS. 14A and 14B.

FIGS. 14A and 14B show that tense is a flat template containing three generated form nodes, while number has structure and contains two generated form nodes (“Sing” and “Plur”). “Sing” and “Plur” have one child each, both children being a reference to tense.

In the embodiment shown, there are several important things to note. First, adding a child reference to an affix group class results in new generated form rows being automatically generated with names computed by concatenating the name of the generated form node plus “.” with the names of the rows in the child affix group class.

Also, even though 14B depicts an affix group class in edit mode, the rows belonging to tense are shaded out in number's tree. This is because although the two references to tense belong to number, the actual contents of tense do not. The author therefore cannot edit the names (“Past”, “Present” and “Future”), standalone status (all “true”) or children (no children) of the three generated form nodes in tense.

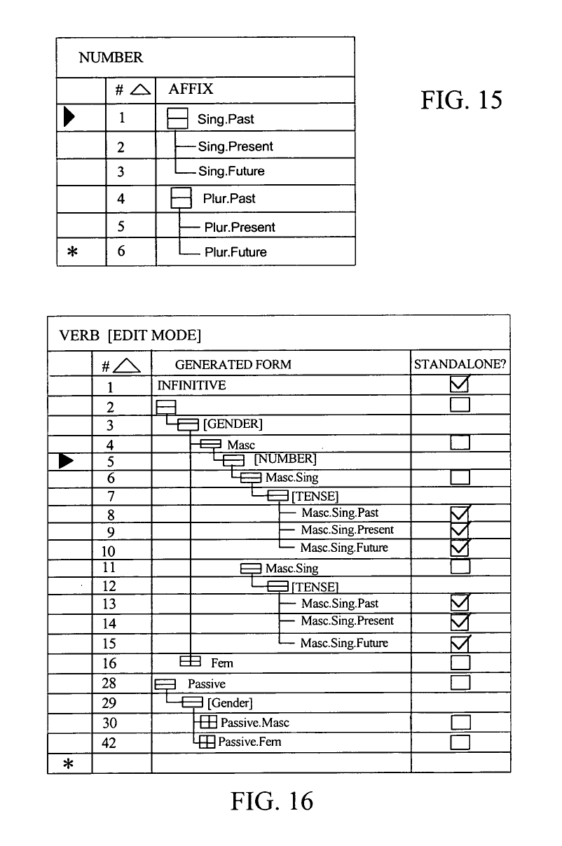

In addition, the impact of “Standalone?” being false for the two generated form nodes in number will not be obvious until we exit edit mode, when we will see the display shown in FIG. 15.

Note from FIG. 15 that there are only 6 rows and that “Sing” and “Plur” are not present as distinct rows, but only their child rows “Sing.*” and “Plur.*” are. This shows the effect of the “standalone” flag, that is, standalone Generated Form nodes are both rows themselves and, optionally, hosts for child affix group classes that will add other rows. Non-standalone nodes serve only as hosts for child affix groups.

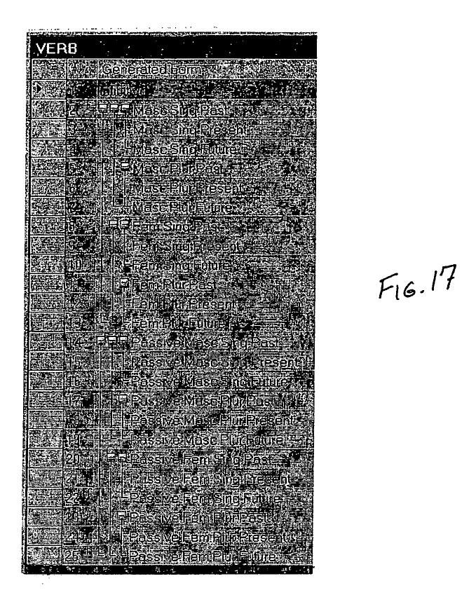

Non-standalone nodes can also have empty names. This is how affix group classes can be embedded “directly” (at the top level of) template class bases. The second generated form node in the verb template class provides an example of this, and is shown in FIG. 16. In order to get verbs to have top-level generated forms called “Masc.Sing.Past”, etc. and because those generated forms are defined in the gender affix group class, the author simply creates a nameless, non-standalone generated form node and attaches gender to it. Note that the third node in verb, “passive” is also non-standalone and also hosts gender.

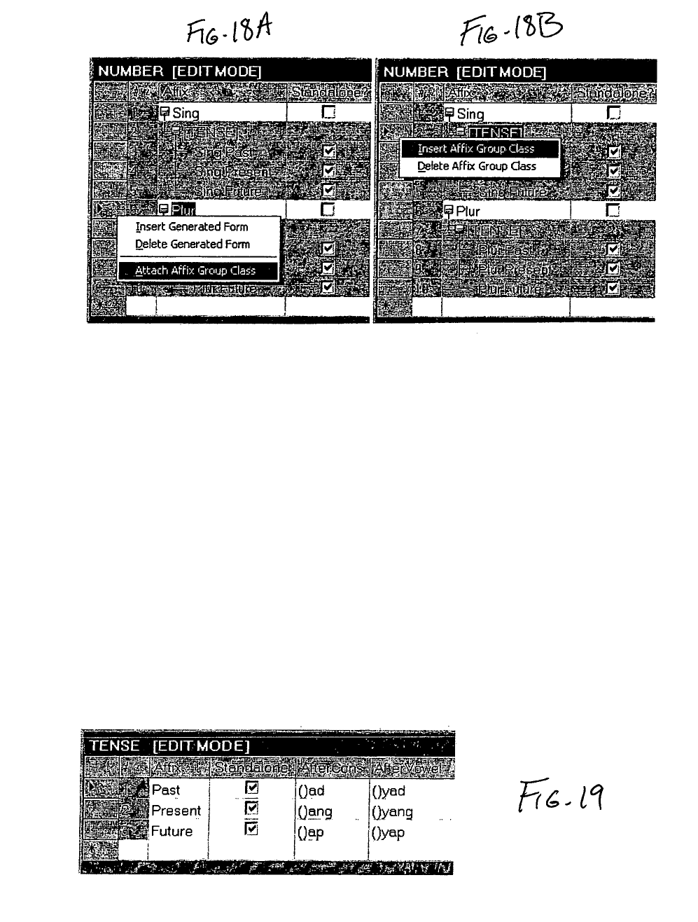

FIG. 17 shows a template as seen outside of edit mode. It should be noted that the checked rows in edit mode correspond both in number and in order to the rows outside of edit mode.

In one illustrative embodiment, adding, inserting and deleting generated form nodes and affix group class children is accomplished by right-clicking on the relevant nodes. New generated form nodes are standalone by default. Examples of context menus that are displayed when the author right-clicks on the “Plur” node and “tense” node are shown in FIGS. 18A and 18B, respectively.

Rules trees will now be described in greater detail. In one illustrative embodiment, the rules tree for any template base (i.e., either a template or an affix group) has precisely the same structure as the generated forms tree of the template base's template class base. That is, it has the same number of top-level nodes, each of which has the same number of children as the corresponding node in the generated forms tree. The type of information that lives on the nodes and the type of the children differ, however.

A Rules tree node carries a single Rule (of the appropriate type—e.g., template rules for rules trees in templates, affix group rules for rules trees in affix groups). Its children, if any, are references to affix groups rather than to affix group classes. It does not have a name or anything corresponding to the “standalone” flag.

As described above, outside of edit mode, the generated forms tree is reduced to a list of named slots corresponding to the checked nodes in edit mode. Some of these slots may have names that were fully specified in the template class base in question but if any generated form nodes had children some names will be computed by reference to information stored in the referenced affix group classes. In a similar fashion a template or affix group's rules tree is reduced to a list of rules, some of which are fully specified in the template or affix group, but some of which may be computed by reference to information stored in referenced affix groups.

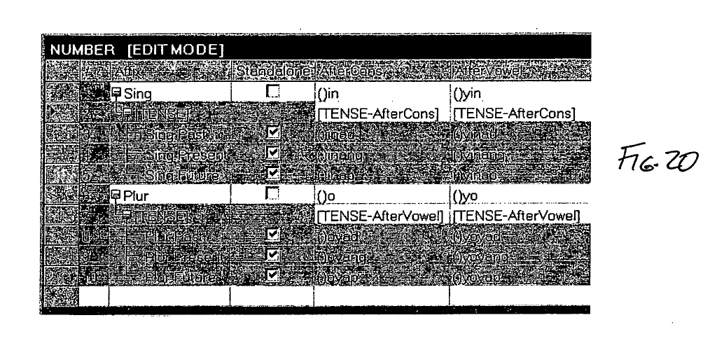

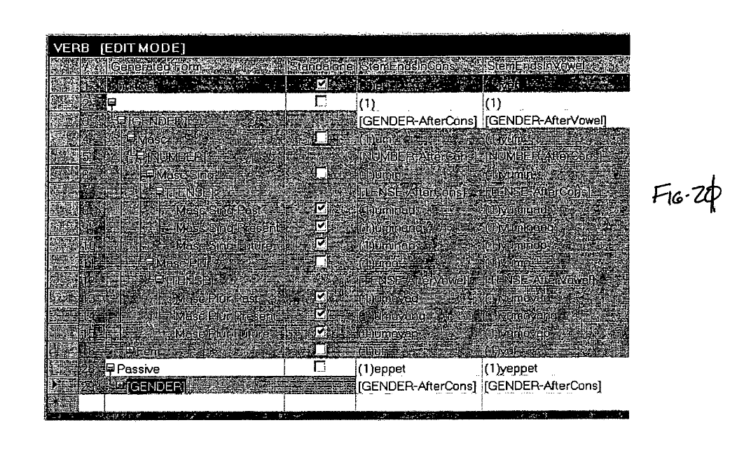

FIG. 19 shows that number and tense each have two Affix Groups: Number-AfterCons, Number-AfterVowel, Tense-AfterCons and Tense-AfterVowel. FIG. 20 shows that, since no nodes in tense have children, the two affix groups simply specify rules for each of the three slots. Number, however, has much more activity.

There are two generated form nodes in number, and both Number-AfterCons and Number-AfterVowel give rules for them. On the rows corresponding to the references to tense, however, they indicate a choice of affix group rather than a rule. The effect of any particular choice is to “cascade” the rule on the rules tree node down “into” the referenced affix group. This creates a “compound” rule in a manner parallel to how “compound” generated form slot names are created. In both cases, in accordance with one embodiment, the generated object is not editable but only the inputs are.

Each reference to a particular affix group class in a generated forms tree can be realized by a different choice of affix group in a corresponding rules tree. In both Number-AfterCons and Number-AfterVowel the first reference to tense is realized with Tense-AfterCons (because the rules ( )in and ( )yin end in consonants), while the second reference is realized with Tense-AfterVowel (since ( )o and ( )yo end in vowels.)

Note that even non-standalone generated forms with null names typically have non-null rules. FIG. 21 shows Verb-StemEndsInCons and Verb-StemEndsInVowel which illustrates why this is so. Without the (1) rule in the second node of the rules trees there would be no input to the rules in Gender-AfterCons and Gender-AfterVowel. In addition, it should be noted that the rules need not necessarily be simply for adding prefixes or suffixes as in the examples discussed above. Instead, the rules may include functions. For instance, assume the following rule (which is a very simple function that has two transformations in the rule represented by a pattern and replacement):

| Pattern | Replacement |
|---|---|
| 1. (.+)<p\|b> | (1)m |
| 2. (.+) | (1) |

The “(.+)” term represents some string in the above transformations. In the first transformation the “<p|b>” represents that the string indicated by the “(.+)” ends in either the letter “p” or the letter “b”. The replacement in the first transformation indicates that the “p” or “b” on the end of the string is replaced by the letter “m”. Let the function identified above be labeled “MyFunction”. In that case, applying the function would act as follows:

MyFunction (“bap”)=“bam”

MyFunction(“cat”)=“cat”

Because “bap” is some string that ends in the letter “p” it matches pattern 1 and the letter “p” is replaced by the letter “m” to obtain “bam”. However, because “cat” is a string that does not end in “p” or “b” it is simply copied over as “cat”.

Rules can use functions by referring to them by name and optionally adding additional affixes. Take the rule “(MyFunction(1))”, which simply calls “MyFunction” and does not add any affixes onto the result. Note that rules are many-to-one relations between strings. In other words, all rules, including rules that use functions, have only one output value for any given input value. When rules are reversed, however, it is possible that there are multiple possible inputs for a given output. When the rule “(MyFunction(1))” is reversed against the word “bam”, for instance, there are three possible results as proposed stems—“bap”, “bab” and “bam”. All three of these strings are transformed into “bam” when passed to MyFunction and, hence, to the rule “(MyFunction(1))”.

In accordance with one embodiment of the present invention, each of the proposed stems generated by reversing the rule is given its own possible analysis. Therefore, at block 616 it will be determined that the rule applies to this input word. Then, at block 620, each of the transformations is applied to generate three proposed stems, and each proposed stem is associated with a separate possible analysis as processing continues at block 622.

In one embodiment, functions are provided which feed other functions. For instance, a nested function can be used, such as (MyFunctionA(MyFunctionB(MyFunctionC(1)))). In such an embodiment, all proposed stems generated by reversing the rules are given their own possible analyses.

It is also worth noting that, in one embodiment of the present invention, a dynamic full form lexicon is maintained. In other words, all of the lexical entries represented in terms of templates have associated word forms that are generated from those templates. A full form lexicon is simply a list of all the words represented by all of the lexical entries in the lexicon. In accordance with one embodiment of the present invention, lexical data manager 240 maintains this list. Then, whenever any additions, deletions or changes are made to any given template, the dynamic full form lexicon is updated to reflect those changes.

One way in which the dynamic full form lexicon is used is to identify which words in the input word list are already in the lexicon, and to generate the check marks adjacent those words as shown in FIGS. 12A and 12B. Alternatively, the present invention can provide a mechanism by which the user can have the dynamic full form lexicon displayed simply as a word list. The length of this word list at any given time (in other words, the size of the dynamic full form lexicon at any given time) is equal to the count of “distinct generated forms” as described above and as displayed in the title bar of the lexical entries table 410 in FIG. 6A.

Another note is that the present invention may illustratively enable fuzzy affix matching. For instance, it is common in some languages that multiple affixes are appended or prepended to a given word. Fuzzy affix matching allows possible analyses to be generated for a given word, even if the entire analysis is not located for that word. In other words, suppose a word “stemxyzabcdef” consists of the stem “stem” followed by the three suffixes “xyz”, “abc” and “def” appended to one another. Also, assume that a rule has been set up for a stem with the suffix “xyz”. Fuzzy affix matching would identify that rule as a possible analysis for the word “stemxyzabcdef” even though there is nothing in the rule corresponding to the affixes “abc” and “def” This provides the author with a starting point from which to modify the template to add additional generated forms and rules corresponding to the input word.

It can thus be seen that the present invention provides significant advantages over prior art systems. The present invention provides an overall system and process for generating a lexicon from a data corpus or word list all the way through a lexicon usable by one or more natural language applications or other components. The present invention also provides a mechanism for authoring template classes and templates and managing those templates and associated data structures, as well as the functions and constraints found in those data structures. The present invention further provides a system for automatically matching input words against the authored templates to generate the lexicon. Further, the present invention provides a system for pre-analyzing an input word list based on context, by filtering the input list to remove unwanted words, and also by scoring the input words against templates using the automatic template matching component. Of course, other advantages are derived as well.

Although the present invention has been described with reference to particular embodiments, workers skilled in the art will recognize that changes may be made in form and detail without departing from the spirit and scope of the invention.

What is claimed is:

1. A computer implemented method of making a lexical entry in a lexicon, comprising:
receiving an input word;
automatically identifying one or more predefined templates defining a stem value and morphological properties corresponding to the input word; and
generating a possible analysis for each identified template by generating the stem value in the identified template from the input word and by expanding the stem value to inflected forms in the identified template.

2. The method of claim 1 and further comprising:
receiving a selection input indicative of a user selection of one of the identified templates; and
assigning the input word to the selected template to obtain a lexical entry.

3. The method of claim 1 wherein the inflected forms in each of the identified templates are defined in the identified templates by a set of rules applied to an associated stem value, and wherein automatically identifying one or more templates comprises:
calculating whether a rule in the set of rules for a template under analysis is reversible given the input word to obtain a proposed stem value.

4. The method of claim 3 wherein automatically identifying one or more templates comprises:
if the rule in the set of rules is reversible given the input word, then calculating whether the proposed stem value meets any constraints on the stem value associated with the rule.

5. The method of claim 4 wherein identifying one or more templates comprises:
if the rule in the set of rules is reversible given the input word, and if the proposed stem value meets any constraints on the stem value associated with the rule, then adding the template under analysis to a set of matched templates, each yielding a possible analysis of the input word.

6. The method of claim 5 wherein identifying one or more analysis comprises:
scoring each possible analysis, generated based on the set of matched templates, to obtain a rank ordered set of possible analyses.

7. The method of claim 6 wherein scoring comprising:
calculating a score based on an edit distance between the input word and the stem, wherein the score is higher if the edit distance exceeds a given value.

8. The method of claim 6 wherein scoring comprising:
calculating a score based on whether the possible analysis includes more than one stem value.

9. The method of claim 6 wherein receiving an input word comprises:
receiving an input word list including a plurality of words; and
wherein scoring comprises calculating a score based on whether any rules in the matched template generate a word in the input word list given the proposed stem value.

10. The method of claim 1 wherein receiving an input word comprises:
receiving an input word list; and
sorting words in the input word list based on a score indicative of how closely the words match any of the predefined templates.

11. The method of claim 1 wherein receiving an input word comprises:
receiving an input word list; and
sorting words in the input word list based on heuristic information corresponding to the words in the word list.

12. An automatic template matching component for matching an input word to a lexical template to generate a lexical entry in a lexicon, comprising:
a template matcher configured to receive an input word and automatically identify a set of lexical templates that match the input word, each lexical template including a stem slot and a plurality of rules defining morphological properties of a stem value in the stem slot.

13. The automatic matching template matching component of claim 12 and further comprising:
a scoring component configured to score each of the set of lexical templates based on how closely the lexical templates match the input word.

14. The automatic template matching component of claim 12 wherein the template matcher is configured to identify the set of lexical templates by determining whether the rules are reversible given the input word.

15. The automatic template matching component of claim 14 wherein the template matcher is configured to identify a template as being in the set of templates if a rule in the template is reversible given the input word to obtain a proposed stem and if the proposed stem meets any stem constraints for a stem value corresponding to the rule.

16. The automatic template matching component of claim 12 wherein the input word is provided in an input word list and wherein the template matcher is configured to sort words in the input word list based on a score indicative of how closely the words match a lexical template.

17. The automatic template matching component of claim 12 wherein the input word is provided in an input word list and wherein the template matcher is configured to sort words in the input word list based on heuristic information associated with the words in the word list.

18. A computer readable medium storing computer readable instructions which, when executed, cause a computer to perform steps comprising:
receiving an input word;
automatically identifying one or more predefined lexical templates defining a stem value and morphological forms corresponding to the input word; and
generating a possible analysis for each identified template by generating the stem value in the identified template from the input word and by applying morphological form rules in the identified template to the input word.

19. The computer readable medium of claim 18 wherein the morphological form rules in each of the identified templates comprises a set of rules applied to an associated stem value, and wherein automatically identifying one or more templates comprises:
calculating whether a rule in the set of rules for a template under analysis is reversible given the input word to obtain a proposed stem value; and
if the rule in the set of rules is reversible given the input word, then calculating whether the proposed stem value meets any constraints on the stem value associated with the rule.

20. The computer readable medium of claim 19 wherein identifying one or more templates comprises:
if the rule in the set of rules is reversible given the input word, and if the proposed stem value meets any constraints on the stem value associated with the rule, then adding the template under analysis to a set of matched templates, each yielding a possible analysis of the input word; and
scoring each possible analysis, generated based on the set of matched templates, to obtain a rank ordered set of possible analyses.
